(19) United States
(12) Patent Application Publication
(10) Pub. No.: US 2021/0312495 A1
(43) Pub. Date: Oct. 7, 2021

(54) SYSTEM AND METHOD FOR PROACTIVELY OPTIMIZING AD CAMPAIGNS USING DATA FROM MULTIPLE SOURCES

(71) Applicant: Syed Danish HASSAN, Toronto (CA)

(72) Inventor: Syed Danish HASSAN, Toronto (CA)

(21) Appl. No.: 17/260,016

(22) PCT Filed: Jul. 12, 2019
(86) PCT No.: PCT/IB2019/055968

§ 371 Date: Jan. 13, 2021

Related U.S. Application Data
(60) Provisional application No. 62/697,439, filed on Jul. 13, 2018.

(51) Int. Cl. G06Q 30/02; G06F 9/54; G06N 3/08

(52) U.S. Cl. CPC G06Q 30/0244; G06N 3/08; G06F 9/547; G06Q 30/0246

(57) ABSTRACT

A system and method for optimizing ad campaigns, which considers the relationship of items and immediately takes into account the future estimated impact of optimizations.

### FIELD OF INVENTION

The present invention pertains to optimization of advertising campaigns, and in particular to such optimization according to hierarchical relationships between items to be optimized that also takes into account the impact of optimizations immediately.

### BACKGROUND OF THE INVENTION

Website operators typically auction their ad inventory on a cost-per-click (“CPC”), cost-per-mile (“CPM”), or cost-per-action (“CPA”) basis. The bidding from advertisers is on the operator themselves (like Google Adwords for traffic on their Google properties), or a range of intermediary entities that facilitate the buying and selling across many website operators and advertisers. Any platform that allows the purchase of a website's ad inventory may be called a “traffic source”.

Traffic sources usually allow advertisers to at least specify targeting information, ads and bids during the creation of their campaigns. Targeting options vary by traffic sources, but may include a placement/website (like “games.com”), specific ad slots in webpages, or any attainable characteristic of the visitor—including their demographics, geographic locations, device types, or even previous behaviours and interests. The process of submitting the ad itself may entail providing a graphical image, video, URL, and/or a snippet of code that will fetch the ad's code through a third-party ad server. The advertiser may also be asked to supply a bid type (like “CPC”) and amount.

Some traffic sources allow advertisers to track when a conversion occurs in their interface. A “conversion” is any action that may be taken by a visitor; such as a purchase, filling a lead generation form, or downloading an application. It is tracked by executing a code that relies on browser cookies (often called a “pixel”) or a URL (often called a “postback”) when a conversion occurs, allowing the traffic source to attribute the conversion to a particular click or impression in their database. Patents such as U.S. Pat. No. 8,898,071 (System and method for managing and optimizing advertising networks; Acquisio Inc.) discuss the optimization of campaigns, based on rules that rely on the traffic source's tracking of such actions.

However, the scope of elements that a traffic source can track is limited. For example, while a traffic source would notice the impact of design optimizations on an advertiser's website through an increase or decrease in “conversion rates” (defined as the percentage of visitors viewing or clicking the ad that convert), it would be oblivious that an on-page optimization was the cause. Any optimization technology that relies on the traffic source's tracking of conversions would overlook the possibility that previously unprofitable and paused elements may now be profitable, due to a change made by the advertiser that is unrelated to the traffic source.

Online advertisers are increasingly using in-house or third-party tracking tools/platforms to monitor the performance of their advertising campaigns. Examples of these “tracking platforms” include Voluum (https://volume.com) and Thrive Tracker (http://thrivetracker.com). Among other benefits, these tracking platforms provide advertisers greater accuracy, convenience, flexibility, reporting granularity, data and features:
Greater accuracy by allowing users to track conversions using both pixels and postback URLs; whereas some traffic sources only offer the less accurate pixel-based tracking
Convenience through centralized reporting of conversions across multiple traffic sources
Flexibility by letting the advertiser define the parameters that they want tracked. For example, the platform may provide a tracking link like this to advertise on traffic sources:_ http://trackingplatform.com/?campaign=123&site=[site]keyword=[keyword]

In the above, the user may specify “google.com” as the ‘site’ if they are advertising on Google, and “insurance” as the ‘keyword’ if that's the search term that they are bidding on. As such, they would submit the ad with a tracking link like this:
http://trackingplatform.com/?campaign=123&site=google.com&keyword=insurance

Typically, each click to the above tracking link would record a unique identifier (“click ID”) in the tracking platform's database, with the related attributes. For example, in addition to the parameters that the advertiser is passing in the tracking link (such as the keyword being “insurance”), the tracking platform may record attributes about the visitor like the device being used for later reporting. The click ID may be stored in a cookie or passed along in the URL chain to the checkout page, so that any conversion can be properly allocated in the tracking platform. When the visitor converts, the tracking platform is then able to retrieve all the relevant information through the click ID that converted.

At the time of conversion from this particular ad, the advertiser can establish that it came from the site “google.com” and the search keyword “insurance”. The advertiser may then compare the combination's revenue in the tracking platform with the amount spent on the traffic source to calculate profitability; or the revenue in the tracking platform with number of clicks or impressions in the traffic source, to determine how much to bid profitably.

Tracking platforms offer reporting granularity by allowing advertisers to analyze data combinations in drill-down reports. For example, the advertiser may also use the above example's tracking link to advertise on “yahoo.com” for the “insurance” keyword. As such, they may advertise the following tracking link:
http://trackingplatform.com/?campaign=123site=yahoo.com&keyword=insurance

In the tracking reports, the advertiser can then assess how the “insurance” keyword performed across multiple traffic sources. This differs from traffic source-based conversion tracking, which would be unable to aggregate data from other traffic sources to achieve statistical significance sooner. By aggregating data across a multitude of traffic sources, advertisers can more efficiency reach conclusions; for example, about which ads or landing pages perform best.

Extensive data is provided by tracking platforms, beyond what a traffic source can typically track. Examples of this data include how conversion rates differ between products on a website, the click-through rates on websites, and how much time visitors spent on various pages.

Additional features are provided by tracking platforms that traffic sources are unable to offer. An example of this includes the (possibly weighted) rotation/split-testing of webpages to monitor impact on conversion rates.

However, despite the increasing usage of tracking platforms, these platforms are still limited in their features and capabilities when optimizing ad campaigns on traffic sources. While not an exhaustive list, below are examples of issues that still exist:
Mismatches may exist between what the traffic source calls an item, and what the user of a tracking platform subjectively names it. For example, a traffic source may call the specific website on which the ad is displaying a “placement”; while a user labels the parameter in the tracking platform “site”. Such inconsistency in naming would typically prevent the matching of item to perform ad optimizations using the tracking platform and traffic source's application programming interfaces (“APIs”).
Advertisers are unable to perform automated optimizations on the traffic source based on non-traffic source data that may be gathered by a tracking platform. For example, traffic sources would be oblivious to on-page data like the “average time spent” by visitors coming through various placements (something a tracking platform could know). In this case, a very short average time detected by a tracking platform may imply fraudulent traffic by a publisher. An advertiser would benefit by deactivating the placement early, rather than waiting until traditional cost-based rules are exhausted.
The relationship of items and immediate impact of optimizations may be ignored. For example, consider the pausing of a landing page that converts 20% lower than others. Theoretically, this should increase the return on investment (“ROI”) of other items that depend on the landing pages—such as ads—by 20% as well. However, a human may overlook this relationship when separately optimizing ads after removing the underperforming landing page, and unnecessarily pause ads that would now be profitable.
There is no retroactive and/or proactive assessment of optimizations. If a user performs a non-traffic source optimization that impacts the overall campaign for example, current tracking platforms and traffic sources would both be oblivious in applying the change retroactively and/or proactively to items being optimized. Similar to the previous example, removing an underperforming landing page may improve the campaign's ROI by 20%. To maximize profitability, advertisers should in this case reassess dependent items that were paused because they fell short of targets by 20% or less.
Impact of each traffic source action is not tracked. For example, by continuously monitoring the impact of each optimization, the advertiser could continue lowering bids until their ad position changes. Were they tracking the impact of actions, they could then revert to the last decrement before the ad position changed. Among many possibilities, this would allow the advertiser to imitate generalized second-price auctions on traffic sources where it isn't supported.
Advertisers are unable to apply more or less weight based on the age of data. Factors outside of the advertiser's control can impact campaign performance. When analyzing data over rolling frequencies (such as “last 7 days”), advertisers are unable to assign more weight to recent data. It follows that advertisers would currently react more slowly to external events impacting their campaigns.
Advertisers are unable to specify optimization hierarchies. For example, pausing an unprofitable device would exclude an entire audience; which would have a detrimental impact on spends. Instead, it is possible that optimizing a less important item first (such as ads) would improve ROI sufficiently so as to not warrant any device optimizations.
Advertisers are unable to track the direction of every optimization. Lowering an ad's bid should theoretically increase profitability, but this may not always be the case (for example, if the ad position drops to “below the fold” and a competing ad is shown first). This task is further complicated with multiple optimizations, as their compounded impact needs to be removed in order to assess the success of an optimization in isolation. Lastly, every action should be assessed prior to being executed, so that a historically failed optimization is not repeated.

Because of the limitations of tracking platforms and traffic sources, there is a need for a system and method for optimizing ad campaigns in traffic sources using independent tracking platforms, which immediately takes into account the future estimated impact of optimizations.

### SUMMARY OF THE INVENTION

The present invention, in at least some aspects, pertains to optimization of advertising campaigns through recognizing the relationships of items when optimizing campaigns and the order in which they are optimized (hierarchies). Various types of optimizations are possible within the context of the present invention. Without wishing to be limited by a closed list, such methods include monitoring the direction of previous optimizations, maximizing campaign rules and goals (rather than simply “satisfying” them), restarting previously paused items, and imitating second-price auctions on platforms that do not support it.

According to at least some embodiments, the present invention provides an optimization engine for not only estimating the impact of such optimizations, but for modeling the potential impact of a plurality of different optimizations, and then selecting one or more optimizations to be applied. Preferably the optimization engine receives information regarding performance of an advertising campaign across a plurality of traffic sources and also a plurality of different tracking platforms. As noted above, each such source of information has its own advantages and brings particular clarity to certain aspects of the optimization. The optimization engine then determines a plurality of potential optimizations. These potential optimizations may involve for example dropping a certain device type, such as mobile device advertising versus advertising on larger devices, such as for example laptop, desktop and/or tablet devices. Various examples of these different optimizations that may be modeled are given below.

When modeling, the optimization engine models an effect of differentially applying the plurality of potential optimizations on the advertising campaign. The differential application may relate to applying each optimization separately and then one or more combinations of a plurality of optimizations. More preferably, a plurality of different combinations of a plurality of optimizations is considered. The engine then preferably determines an appropriate change to the advertising campaign according to the modeled effect.

The power of modeling different combinations of optimizations and then selecting a particular combination according to the model results is that considering each separate optimization in isolation may not provide a true picture of the best advertising campaign parameters to apply in order to obtain the best overall result. When advertisers seek to optimize individual advertising campaign parameters separately, they do so in the hope of determining the best overall advertising campaign. However, treating each such parameter in isolation may not provide the best results.

For example, if an advertiser pauses an under-performing ad, the overall campaign's performance would be expected to increase in the future. If the advertiser separately optimizes devices, without consideration of the impact on the campaign of both pausing an underperforming ad and also optimizing for device display together, the advertiser may choose separately to stop display on mobile devices. Yet these two separate selections may not in fact provide the best overall result for the campaign. The optimization engine would reveal whether applying both optimizations together is best, or whether a different set of optimizations would provide the best overall result.

If the advertiser is then optimizing devices, they may not need to pause an under-performing device type (ie. mobile) if they were able to apply the estimated impact of the optimization they just made immediately (pausing the under-performing ad). The optimization engine preferably models the estimated impact of potentially thousands of optimizations, and applies it immediately in subsequent calculations before the actual data even reflects the optimization's change. Void of this, advertisers would have to wait for their post-optimization data to outweigh the old (but by then, they may have already made premature decisions which in turn could reduce campaign efficiency).

Preferably the data is obtained and stored to be able to apply the estimated impact of optimizations immediately, through such optimization modeling. For example, the data is preferably stored in intervals that match the level of granularity to which the estimated impact can be applied. For example, if the user pauses an ad at 4PM, preferably the tracking platform and traffic source data is stored at hourly intervals. If the data were to be stored at daily intervals, it would not be possible to apply the estimated impact to all data prior to a particular hour (4 pm). The ability to apply the estimated impact of optimizations immediately requires building the product from the ground-up with this goal in mind.

Without wishing to be limited by a closed list, the present invention optionally provides a number of different optimization features, which may be used separately or in combination, including optimization of advertising campaigns on traffic sources using data from independent tracking tools, thereby allowing more accurate optimizations with possible additional non-traffic source metrics. Another optional feature includes a unique method of storing reports that allows the application of “weights” to data, and the use of a novel “Retroactive Optimization” methodology. Also, the Retroactive Optimization methodology permits the immediate consideration of optimizations using estimated “impacts” (events) when analyzing other campaign items subsequently. The present invention, in at least some embodiments, analyzes proposed actions and adjusts the behavior based on whether it has previously failed.

The present invention is optionally implemented as a system and method to enable advertisers to effectively and proactively optimize their ad campaigns on any traffic source, with the possibility of using data from any independent tracking tool. According to at least some embodiments, the system and method allow the user to associate (dissimilarly) labelled “items”—anything that can be tracked and optimized, including custom tracking parameters—between the tracking platform and traffic source. The association can be done automatically, manually, or a combination of the two. For example, the system can detect that the tracking platform parameter “site” contains domains; which it can then associate with what the traffic source calls a “placement” to perform optimizations using APIs.

Optionally the user can specify the relationship of items. Optimizing certain items may impact everything else in an ad campaign. However, in other cases, optimizing items may only impact other specific items. For example, optimizing mobile ads would impact calculations pertinent to mobile devices only. By allowing the user to specify these relationships, the system can apply the impact of optimizations to affected items only.

The system and method also preferably support specification of an optimization hierarchy. For example, pausing devices or placements will likely have an impact on traffic volume, as it excludes certain audiences that would otherwise see the ads. By having the user specify an optimization hierarchy, the system can optimize items starting from the bottom of the hierarchy. Thus, a user can avoid adjusting bids on more important items until all other options are exhausted. Such a hierarchy can also be applied automatically, by first optimizing items that have the least impact (on spends or traffic volumes for example); or vice versa to optimize items that have the most impact first.

The user is preferably able to define goals and rules, based on which the system would execute actions in the traffic source. These rules can now also be based on data that was previously inaccessible to the traffic source, such as the time on website. For example, if isitors from a particular placement are leaving within a specified average time, the user can blacklist it. As traffic sources do not have access to on-page metrics that a tracking platform might, this was previously unachievable.

According to at least some embodiments, the system and method allow the user to maximize campaign rules and goals. Assume two items are both satisfying all campaign rules and goals, but pausing one of the items would significantly improve the performance of the campaign. While the lesser important item would not have been paused when optimized in isolation, doing so to improve the performance of a more important item (and the campaign as a whole) would be reasonable. In one non-limiting optimization methodology, the system continuously analyzes the impact of pausing/optimizing lesser important items to maximize the campaign rules and goals, rather than simply satisfying them.

Optionally, optimization is further supported by retrieving data from whichever platform is more relevant for greater accuracy. For example, revenue data could be retrieved from the tracking platform; while items pertinent to the delivery of ads—like ad positions, number of clicks and spend—could be retrieved from the traffic source.

Optionally, data is continuously or periodically obtained from the tracking platform and traffic source for each item on an ongoing basis, to log for subsequent optimizations. For example, if the user wants to optimize campaigns “hourly, on a trailing 7-day basis”—reports are fetched for each item, for every hour, from the tracking platform and traffic source. In this case, the hourly data of the previous trailing 7 days would be used for optimizations. Similarly, if the user want wants to optimize campaigns “every minute, on a trailing 7-day basis”—reports are fetched for every item, for each minute. This allows the system to easily calculate the impact of changes immediately, as will be discussed later.

Optionally, data is weighted to increase its significance when it is recent and to decrease its significance as it ages. Given the method in which the system logs performance data from the tracking platform and traffic source (such as for every hour if the campaign is being optimized “hourly”), weights can be applied based on the age of the data. Assume the campaign has 2 hours of data with equal spend in each hour, and the user wants to apply a 60% weight to the second (more recent) hour. If the campaign generated $120 in revenue in the first hour, and $140 in revenue in the second hour, the revenue used for optimizations would be $264 {[($120×40% first hour)+($140×60% second hour)]×2 weights}, rather than $260 ($120 first hour+$140 second hour).

The impact of actions taken is preferably continuously monitored. For example, the system can compare the current ad position with that at the time of the previous optimization. This can be used to simulate second-price auctions on traffic sources that do not support it, by obtaining the preferred ad position or traffic volume at the lowest bid possible. The system can also remove the impact of other optimizations to assess whether a specific optimization is itself moving in the correction direction of the campaign rules and goals.

Optionally, optimization is performed through ongoing calculations to check whether items are satisfying the user's defined goals and rules (after taking into account “events” as described later), rather than waiting for a significant elapsed period of time. Again, assume that the user wants to optimize campaigns “hourly, on a trailing 7-day basis”. The sum of the hourly revenue reports from the tracking platform over the trailing 7 days may show $300 in revenue from a specific placement; while the sum of the traffic source logs show a $280 spend over 200 clicks. Assuming the user had defined a 20% ROI goal, the maximum they could have bid is $1.25/click [($300 revenue/1.(20%) ROI goal)/200 clicks]. As such, the system would lower the bid from $1.40/click ($280 spend/200 clicks) to $1.25/click (as calculated previously) and log the event to a database for other item optimizations to consider. The impact of these “events” can also be applied retroactively then. For example, if a related item previously paused by the system would now be profitable as a result of this optimization, it could now be resumed. Similarly, if the “impact” of this optimization (such as a 10% improvement in campaign ROI) is considered in subsequent optimizations immediately, another item—such as an ad—that fell short of a campaign rule or goal by a smaller percentage would no longer need to be paused. If a retroactive optimization methodology was not used, the underperforming item being optimized would have been paused, as the ROI improvement from other optimizations would not have been a factor until considerably later (once the post-optimization data is sufficient to outweigh the older one).

According to at least some embodiments, a change in a marketing funnel or campaign is examined for its retroactive effect on advertising, in order to predict its future effect on the actual advertising spend and/or return. For example, the user may have made a change in the user's sales funnel that will increase ROI by 20%. While this change would be effective immediately, tracking platforms would not recognize the impact until subsequent data is gathered. Even then, it would not apply the event retroactively to check how previously paused items would be impacted. Expanding on the previous example, the system would retroactively apply the event that increased ROI by 20%; thereby permitting the bid to increase to $1.50/click {($300 revenue×1.20 multiplier)/1.20 ROI goal]/200 clicks}. When performing all subsequent calculations, the system would take into account the impact of this event on the data prior to it (“post-events” data) as if it had always been the case.

Optionally, such events are detected automatically. For example, the system can detect whether the state of an item has changed in the tracking platform (such as a landing page being removed from rotation) to analyze the relevant impact and automatically log the event.

Non-limiting examples of traffic sources include any website that sells ads, including but not limited to content websites, e-commerce websites, classified ad websites, social websites, crowdfunding websites, interactive/gaming websites, media websites, business or personal (blog) websites, search engines, web portals/content aggregators, application websites or apps (such as webmail), wiki websites, websites specifically that are specifically designed to serve ads (such as parking pages or interstitial ads); browser extensions that can show ads via pop-ups, ad injections, default search engine overrides, and/or push notifications; applications such as executable programs or mobile/tablet/wearable/Internet of Things (“IoT”) device apps that shows or triggers ads; in-media ads such as those inside games or videos; as well as ad exchanges or intermediaries that facilitate the purchasing of ads across one or more publishers and ad formats.

A tracking platform may be any software, platform, server, service or collection of servers or services which provide tracking of items for one or more traffic sources. Non-limiting examples of items a tracking platform could track include the performance (via metrics such spend, revenue, clicks, impressions and conversions) of specific ads, ad types, placements, referrers, landing pages, Internet Service Providers (ISPs) or mobile carriers, demographics, geographic locations, devices, device types, browsers, operating systems, times/dates/days, languages, connection types, offers, in-page metrics (such as time spent on websites), marketing funnels/flows, email open/bounce rates, click-through rates, and conversion rates.

Traffic sources may incorporate functionality of tracking platforms, and vice versa. The optimization methodologies as described herein are operational if provided stand-alone, incorporated within a traffic source, tracking platform, or a combination thereof. In such incorporations, the optimization methodologies may for example be applied to the actual data, rather than relying on APIs to query such data from a traffic source and/or tracking platform.

While examples are provided, it should be noted that they are not comprehensive. A person familiar with the digital advertising landscape would quickly recognize the many benefits of optimizing ad campaigns proactively on traffic sources with data from independent tracking platforms.

Optionally each method, flow or process as described herein may be described as being performed by a computational device which comprises a hardware processor configured to perform a predefined set of basic operations in response to receiving a corresponding basic instruction selected from a predefined native instruction set of codes, and memory. Each function described herein may therefore relate to executing a set of machine codes selected from the native instruction set for performing that function.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF THE DRAWINGS

These and other features, aspects, and advantages of the present invention will become better understood with regard to the following description, appended claims, and accompanying drawings where:

FIG. 1 shows an overview of the system according to at least some embodiments of the present invention;

FIG. 2 shows an overview of the continuous optimization process according to at least some embodiments of the present invention;

FIG. 3A shows a sample webpage where the tracking platforms are specified;

FIG. 3B shows a sample webpage where the traffic sources are specified;

FIG. 3C shows a sample webpage where tracking platform and traffic source campaigns are linked;

FIG. 3D shows a sample webpage where the default campaign optimization settings are specified;

FIG. 3E shows various exemplary methods used by the system to associate tracking platform and traffic source items;

FIG. 3F shows a sample webpage where the tracking platform and traffic source items are associated manually;

FIG. 3G shows a sample webpage where campaign optimization rules are specified;

FIG. 3H shows a sample webpage where miscellaneous campaign management rules are specified;

FIG. 4A shows an exemplary overview of the workflow for gathering and logging reports;

FIG. 4B shows a detailed workflow for gathering and logging reports;

FIG. 4C shows a detailed workflow for retrieving/storing “items” and their relationships;

FIG. 4D shows a detailed workflow for fetching item reports by intervals;

FIG. 4E shows a campaign's total spend via breakdown of different items;

FIG. 4F shows why the hierarchy of optimizations matters;

FIG. 5 shows a rationale and explanation of “Retroactive Optimizations”;

FIG. 6 shows an overview of the Retroactive Optimization steps;

FIG. 7A shows a sample webpage where a user can define “events” and their impacts manually;

FIG. 7B shows an overview of the steps after an “event” is manually created;

FIG. 8 shows an overview of the various optimization methods and their common workflow;

FIG. 9 relates to monitoring the direction of previous optimizations for a first optional optimization, including the following: FIG. 9A: Overview of optimization for every previous optimization event; FIG. 9B: Detailed overview of optimization/analysis; FIG. 9C: Alternative presentation of optimization/analysis;

FIG. 10 relates to another optional optimization for Satisfaction of Campaign Rule(s) & Goal(s), including the following: FIG. 10A: Overview of optimization for every item value; FIG. 10B: Detailed overview of optimization; FIG. 10C: Programmatic overview of optimization; FIG. 10D: Programmatic overview of post-event calculations; FIG. 10E: Database query for post-event calculation; FIG. 10F: Programmatic approach for post-event calculations; FIG. 10G: Programmatic overview of data comparison;

FIG. 11 relates to another optional optimization for Maximization of Campaign Rule(s) & Goal(s), including the following: FIG. 11A: Overview of optimization for every item; FIG. 11B: Detailed overview of optimization;

FIG. 12 relates to another optional optimization for Restarting of Paused Item(s), including the following: FIG. 12A: Overview of optimization for every paused item value; FIG. 12B: Detailed overview of optimization;

FIG. 13 relates to an overview of possible action(s) by the system; and

FIG. 14: Overview of how possible action(s) are assessed by the system.

### DETAILED DESCRIPTION

In describing the novel system and method for optimizing advertising campaigns, the provided examples should not be deemed to be exhaustive. While one implementation is described hereto, it is to be understood that other variations are possible without departing from the scope and nature of the present invention.

### Traffic Source & Tracking Platform APIs:

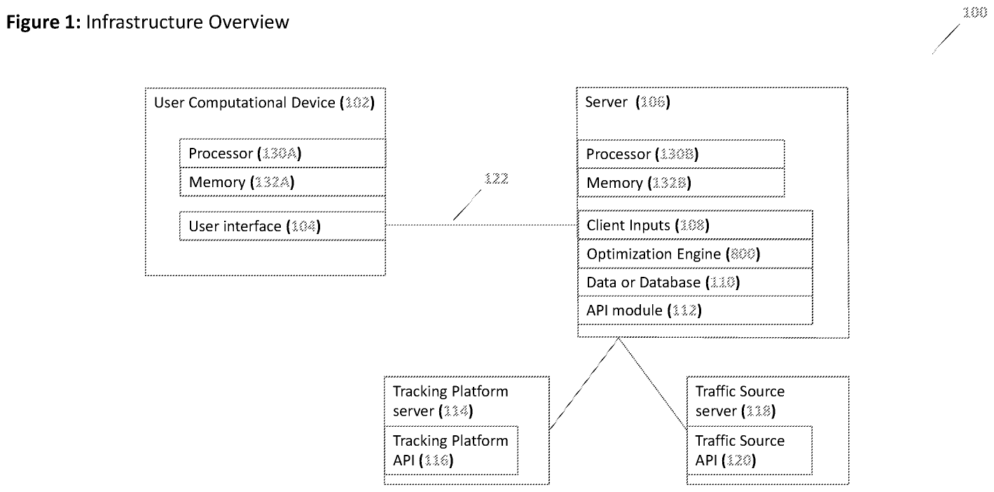

For a particular embodiment, FIG. 1 shows an overview of a system 100 for aggregating traffic source and tracking platform application programming interface (“API”) functions that allow other software modules to interact with the different APIs in an API-agnostic manner. As shown, the system 100 features a user computational device 102, a server 106, a tracking platform server 114, and traffic source server 118.

The user computational device 102 operates a user interface 104, where the user interface 104, for example, displays the results of aggregating traffic source data and receives one or more user inputs, such as commands. The user interface 104 enables the platform to obtain a user's tracking platform and traffic source details, campaign settings, and as well as any optimization/management rules to store into the database (described below).

The user computational device 102 also interacts with the server 106 through a computer network 122, such as the internet for example. The server 106 receives client inputs 108, for example with regard to the advertising campaign to be operated, through the user interface 104. The client inputs 108 are fed to an optimization engine 800, which uses data 110 from a database to determine the type of optimizations that should be performed with regard to the campaign indicated. An API module 112 provides the support for enabling other modules on the server 106, such as the optimization engine 800, to operate in an API agnostic manner. Such support may be described as API abstraction.

The system 100 includes the APIs of various traffic sources and tracking platforms to streamline subsequent queries by the platform, shown as a tracking platform server 114 which operates a tracking platform API 116 and also a traffic source server 118 which operates a traffic source API 120, as non-limiting examples. API module 112 provides communication abstraction for tracking platform API 116 and traffic source API 120. This abstraction enables the platform to call a function to connect with an API—therein passing as variables the name of the tracking platform to load the relevant APIs, and the login credentials to execute the connection. Tracking platform and traffic source reports can then be fetched by the API module 112 to optionally store the data 110 in a database.

User computational device 102 preferably operates a processor 130A for executing a plurality of instructions from a memory 132A, while server 106 preferably operates a processor 130B for executing a plurality of instructions from a memory 132B. As used herein, a processor such as processor 130A or 130B, generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as memory 132A or 132B in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Computational devices as described herein are assumed to have such processors and memory devices even if not explicitly shown. Optionally, each server or platform is implemented as a plurality of microservices (not shown).

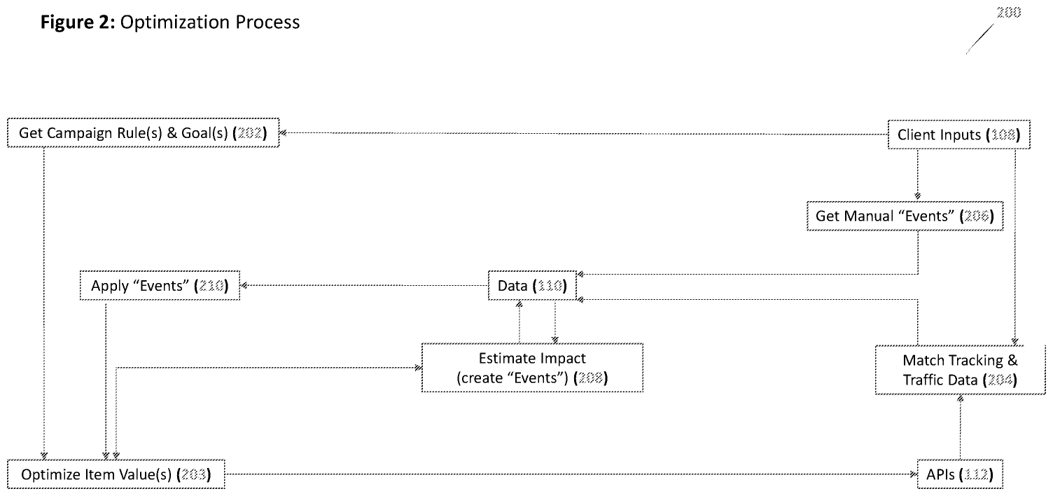

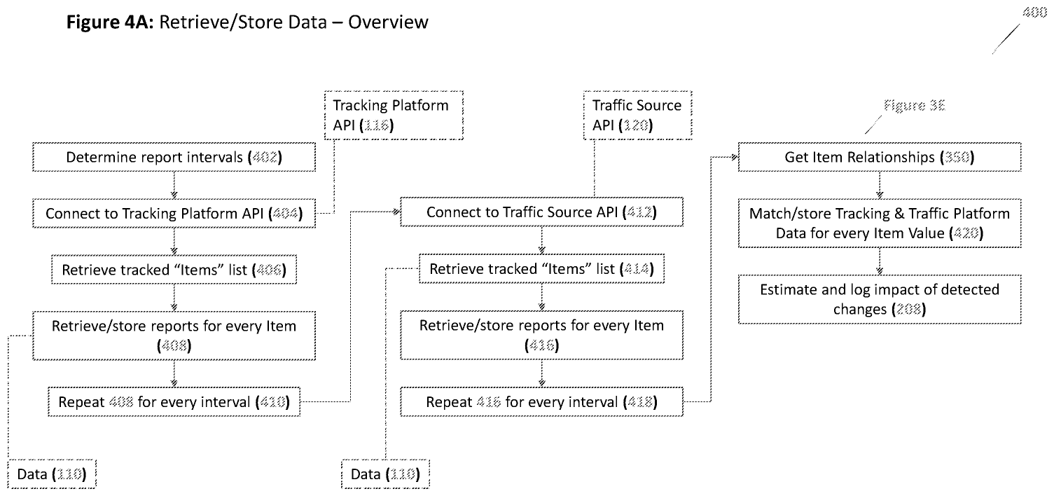

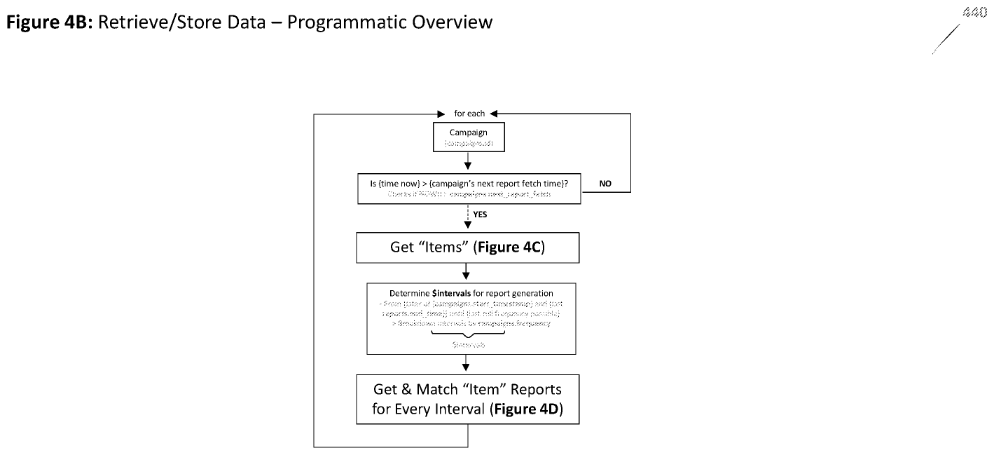

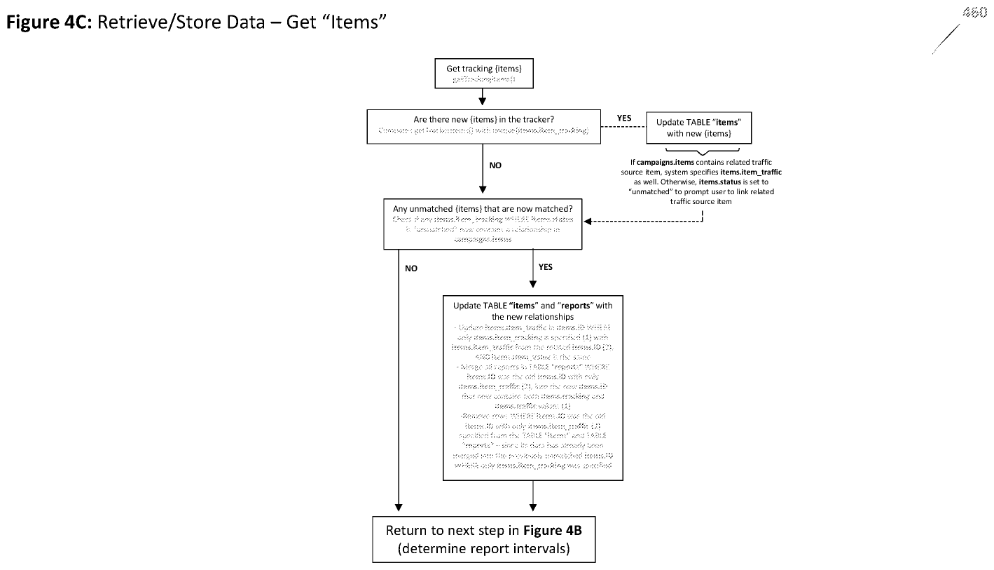

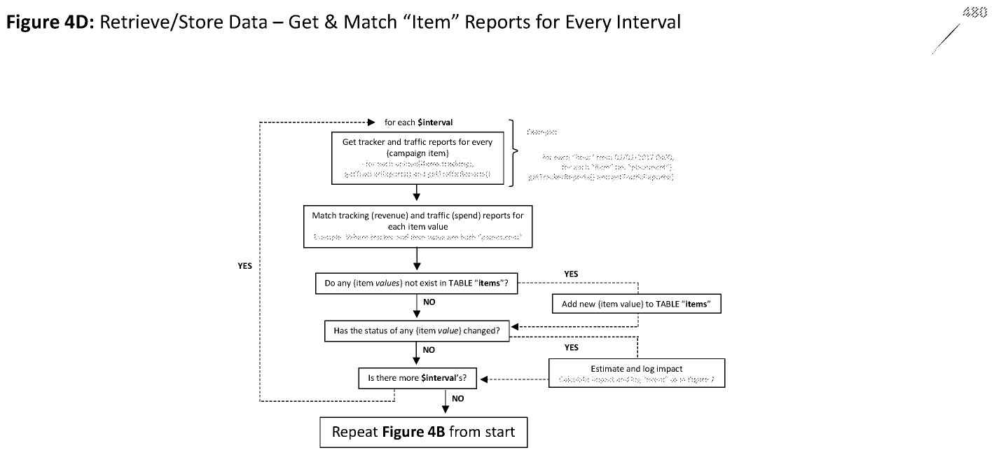

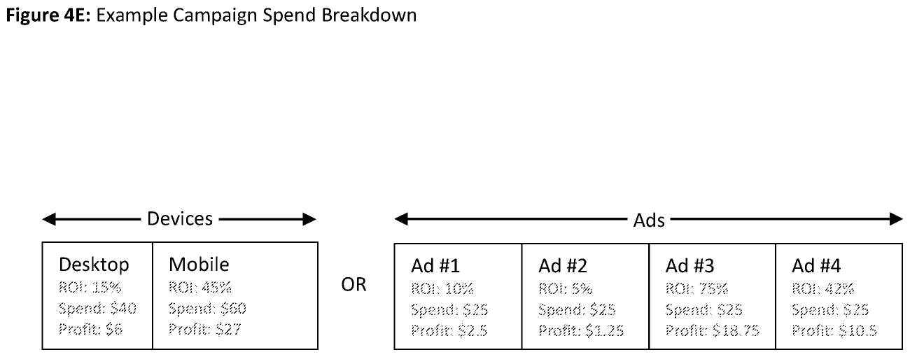

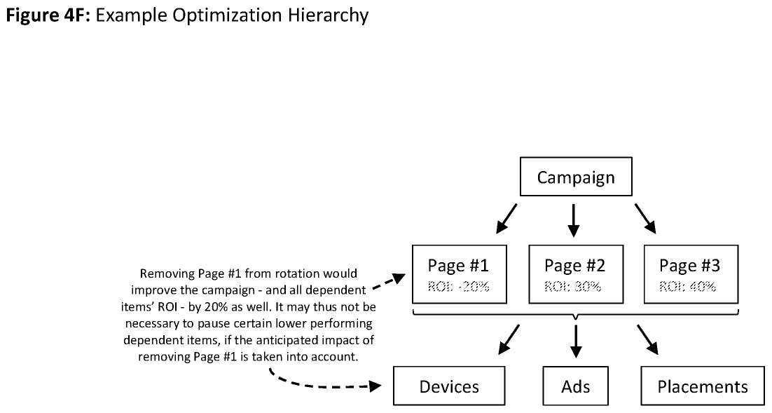

FIG. 2 shows an overview of the continuous optimization process according to at least some embodiments of the present invention. This process is preferably performed for each optimization. The effect of such optimization is preferably cumulative over the performance of a plurality of such optimizations. A Process 200 includes retrieving data using API module 112 that enables communication with external tracking platforms and traffic sources, for matching traffic and tracking data at Step 204, a non-limiting exemplary process for which is described in more detail in FIG. 4A.

The matched data is optionally stored in database 110, described with regard to FIG. 1. The impact of the detected changes in the database 110 is then estimated at Step 208 to create events. Estimate/log “Events” (208) goes both ways with Database (110), since it needs to look at prior data to detect changes/impact of changes (receive data), but also stores these “events” to the database. For example, if the user paused a particular ad manually in the traffic source, the change would be detected like this:
Data is received from APIs (112)>Tracking & Traffic Data is matched (204)>Data is stored (110)>Estimate and log impacts (208) detects change, ie. “item value” was paused in the tracking platform>Impact is estimated and sent back to Data (110)

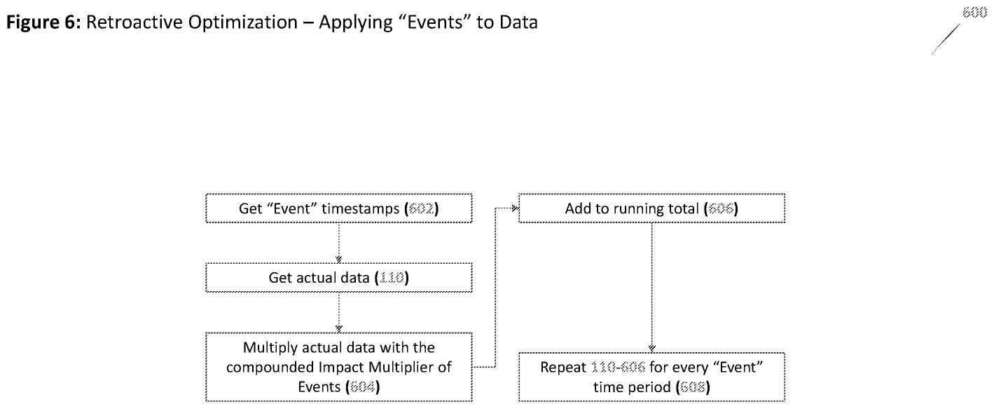

The estimated impact of events may be applied at Step 210, a non-limiting exemplary process for which is described in more detail in FIG. 6. The “post-events” data, after applying the impact of events in Step 210 on data 110, is used when optimizing item values in Step 203.

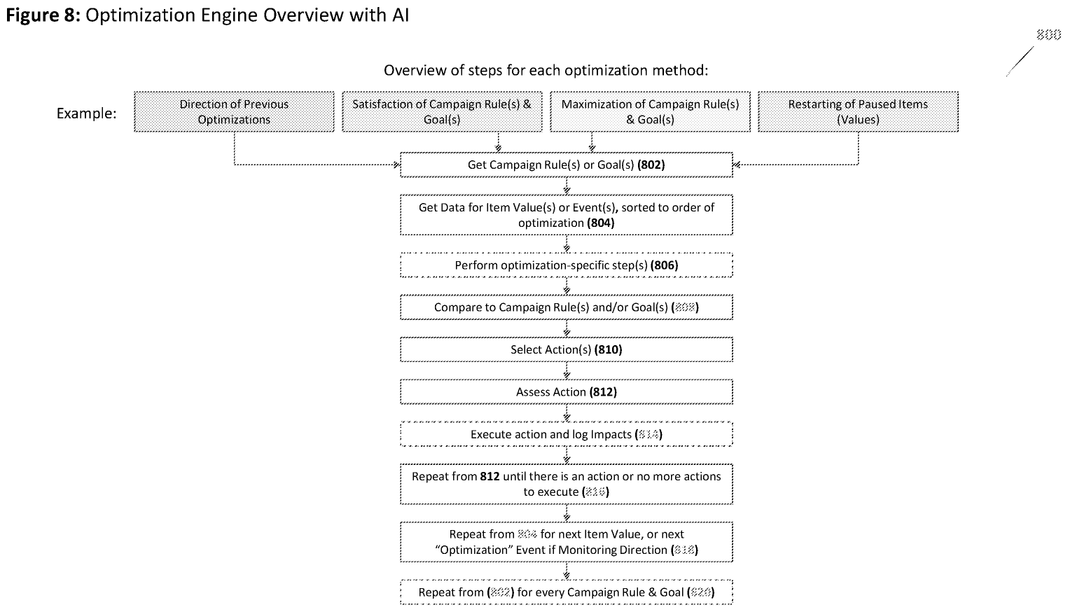

Based on the campaign rules and goals in Step 202, and using the post-events data in 210, item values are optimized in Step 203, a non-limiting exemplary process for which is described in more detail in FIG. 8. The impact of the selected optimizations is estimated in Step 208, which is stored in the database 110. The API module 112 is used to execute the selected actions on the traffic and tracking platforms.

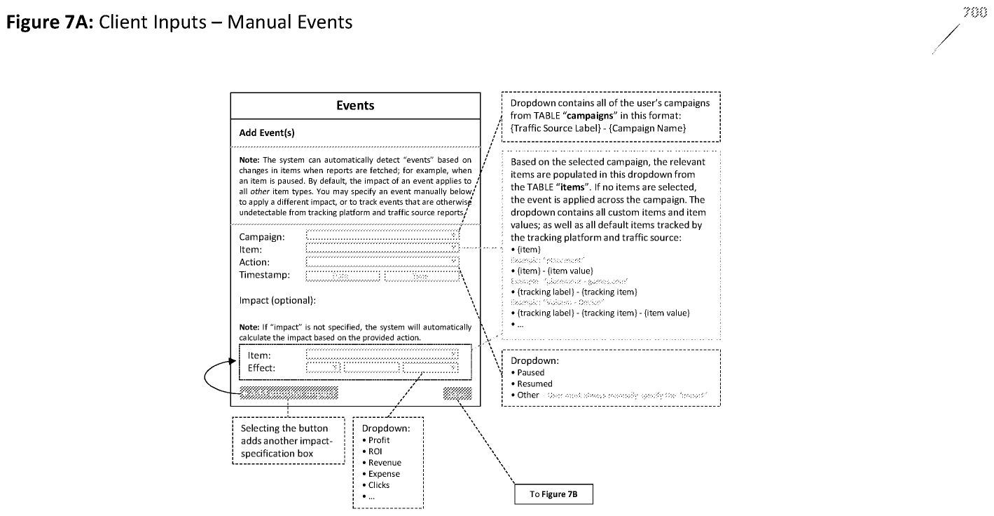

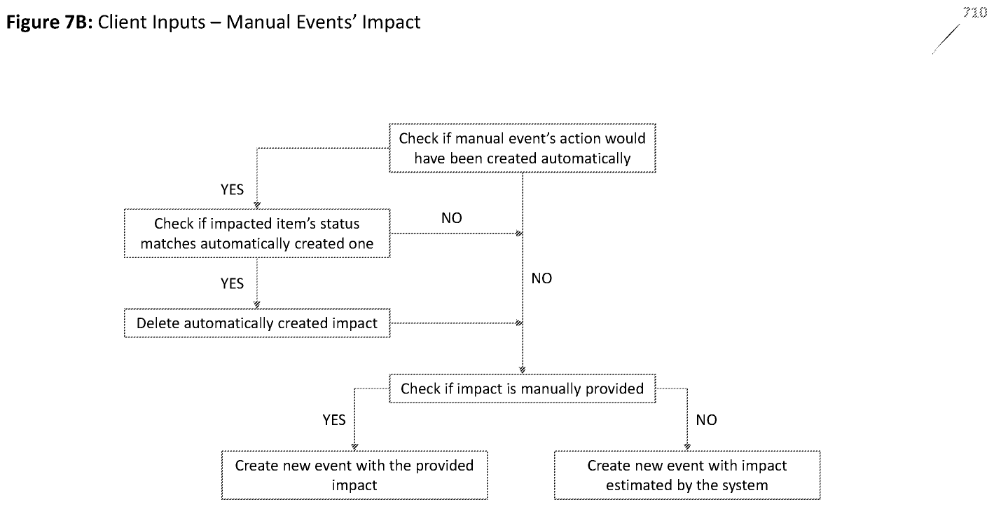

On the upper right side of FIG. 2, client inputs 108, described with regard to FIG. 1, enable the rules and goals to be obtained at Step 202. Client inputs 108 may also be used to determine manual (that is, user-determined) events at Step 206, a non-limiting exemplary process for which is described in more detail in FIG. 7A. The results of the manual events at Step 206 are also fed to database 110. Client inputs 108 may also be used for Step 204.

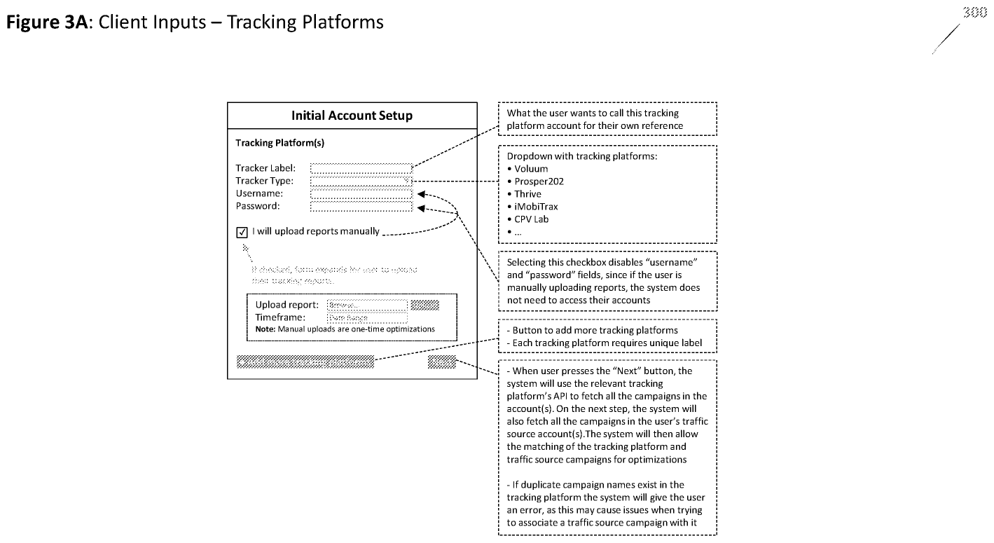

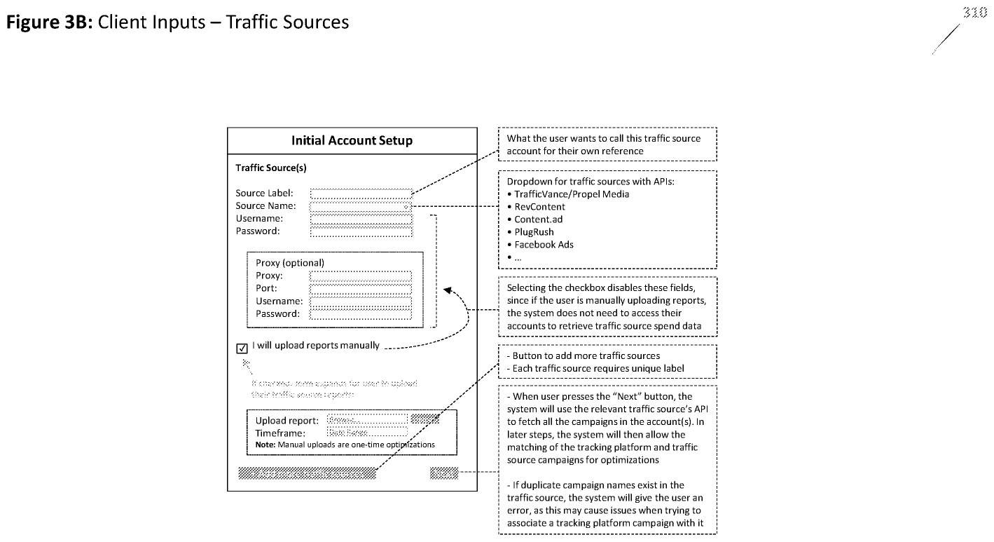

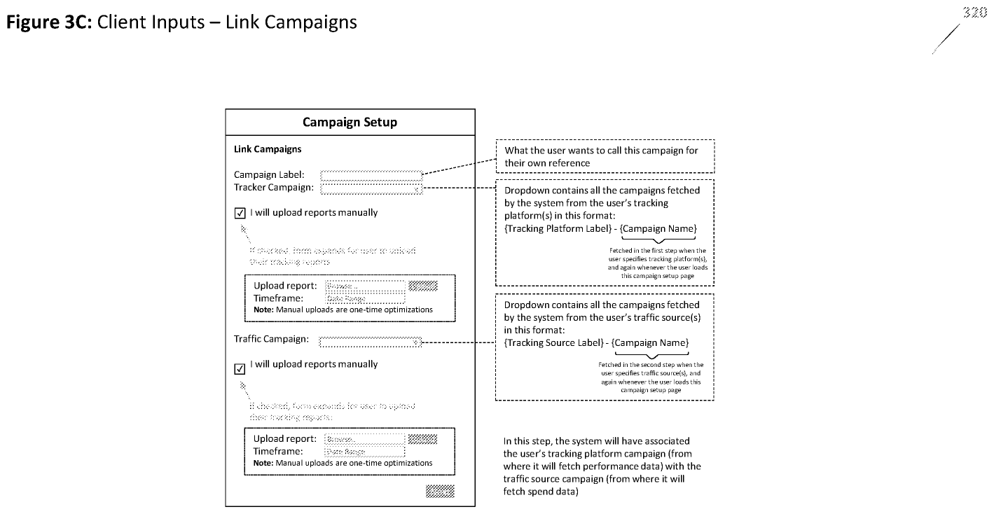

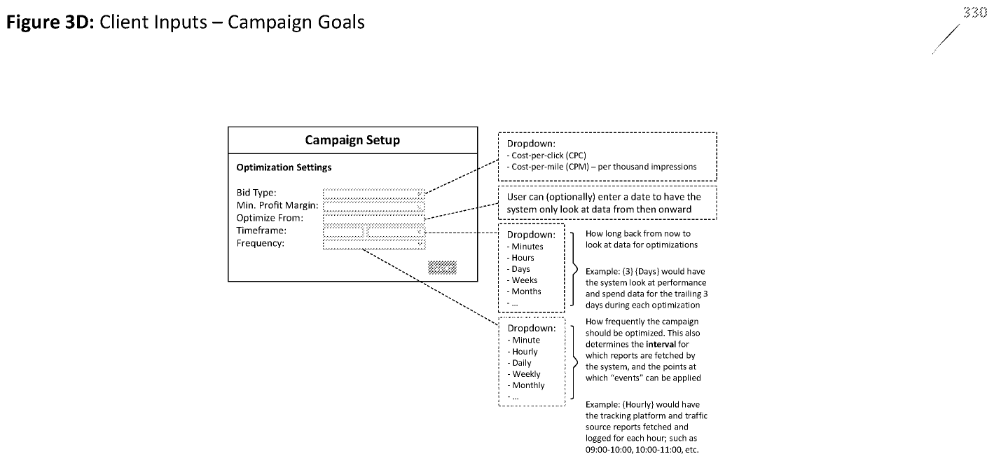

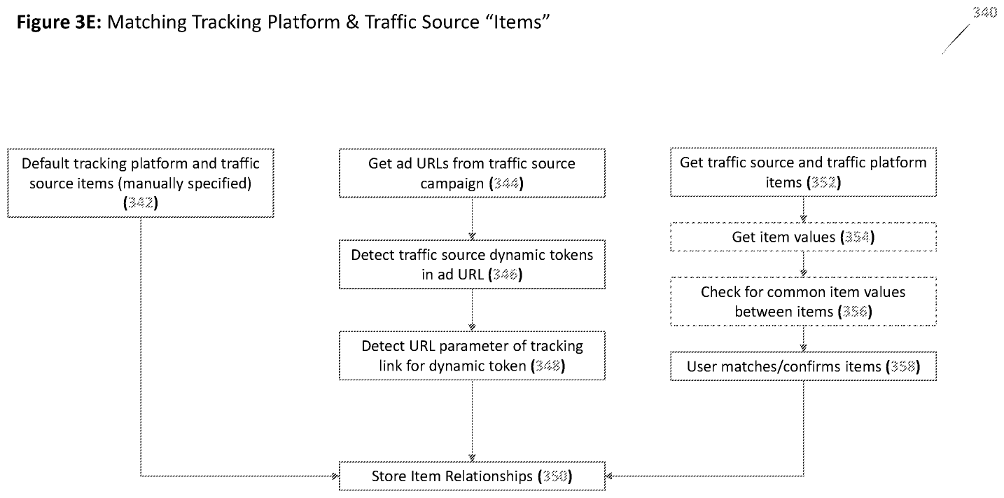

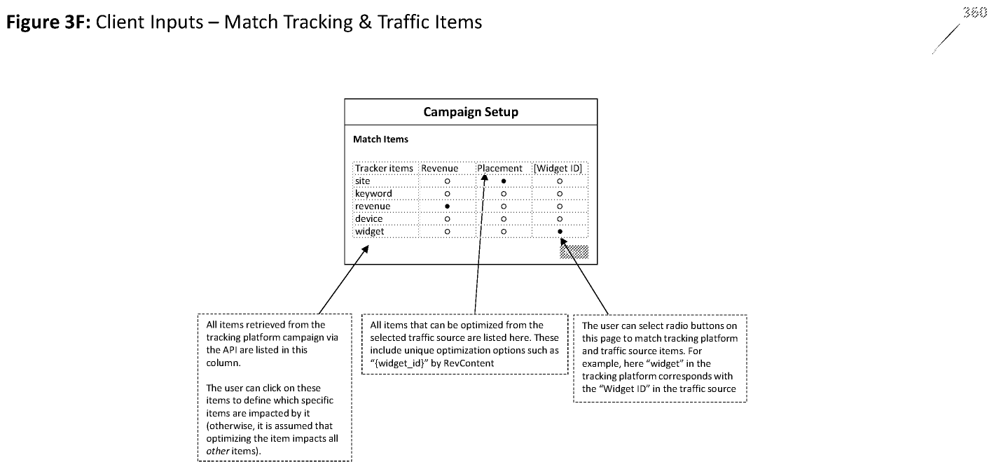

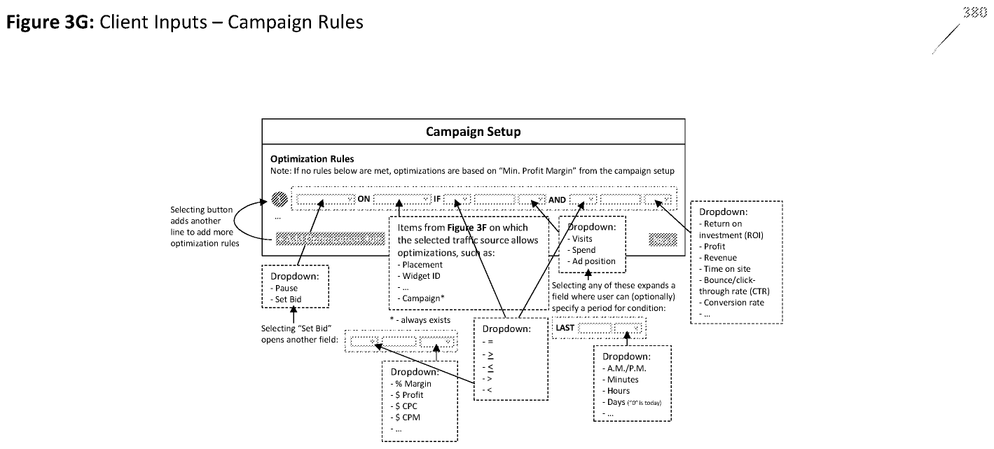

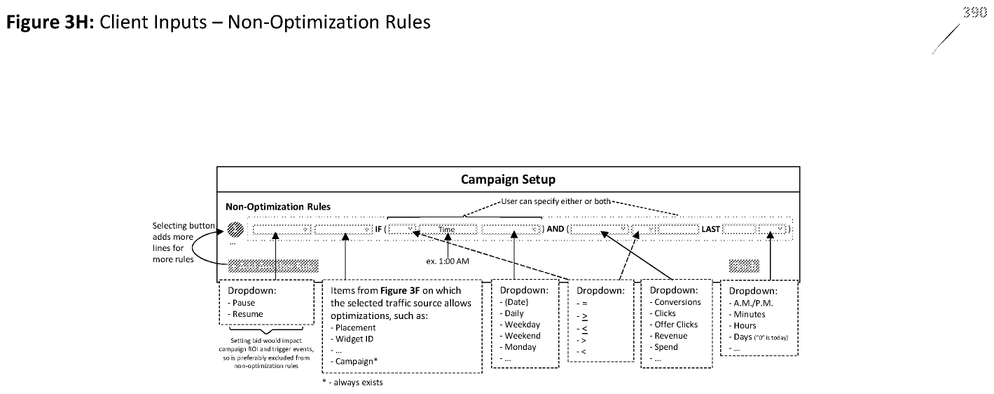

FIG. 3 shows non-limiting examples of various webpages for providing various types of information, along with a method for using the same. FIG. 3A shows a sample webpage where the tracking platforms are specified. FIG. 3B shows a sample webpage where the traffic sources are specified. FIG. 3C shows a sample webpage where tracking platform and traffic source campaigns are linked. FIG. 3D shows a sample webpage where the default campaign optimization settings are specified. FIG. 3E shows an exemplary method to associate tracking platform and traffic source items. FIG. 3F shows a sample webpage where the tracking platform and traffic source items are associated manually. FIG. 3G shows a sample webpage where campaign optimization rules are specified. FIG. 3H shows a sample webpage where miscellaneous campaign management rules are specified.

Turning now to FIG. 3E, a non-limiting exemplary process 340 supports matching tracking platform & traffic source “items”. Default tracking platform and traffic source items (manually specified) are provided at Step 342. Example: If a tracking platform calls an Internet Service Provider (“ISP”), and a traffic source calls it “I.S.P.” by default, the relationship can be defined in the system from the get-go so that optimizations can be done on this item using data from both platforms. The relationships for these items are stored at Step 350.

At Step 344, ad URLs from traffic source campaign(s) are obtained. An example ad URL is http://trackingplatform.com?website={placement}. In Step 346, the URL parameters followed by the “?” in the URL and separated by “&” are extracted (such as “website={placement}”). Based on the known list of dynamic URL parameters that a traffic source supports, it is known that {placement} is the website on the traffic source where the ad served. In Step 348, based on the URL parameter prefixed to {placement}, being “website”, it is known that the placements are labelled “website” in the tracking platform.

For this non-limiting example, since a known dynamic token from the traffic source in the ad URL was detected, it is possible to automatically associate the traffic source item “placement” with the tracking platform item “website” for optimizations. The detected URL tokens and parameters are stored at Step 350.

Next at Step 352, traffic source and tracking platform items are obtained. If available, their item values are obtained at Step 354. The common values between the traffic source and tracking platform are optionally identified in Step 356 to determine how the same item is labelled on both. Preferably, the user confirms any such matches and/or indicates further matches at Step 358, as described in greater detail in an exemplary webpage in FIG. 3F.

Turning now to FIG. 3G, this exemplary interface enables the user to specify one or more rules. With the tracking platform and traffic source items matched, the system can automatically optimize campaigns based on specified rules. For example, the user may want a minimum 20% profit margin on a campaign. In FIG. 3G, the user can specify an optimization rule for this: {Set Bid} TO {≥} {20} {% Margin} ON {Campaign} IF {−} AND {<} {20%} {ROI}. By associating the same item across tracking platforms and traffic sources, automated optimizations can occur using metrics that are unknown to the traffic source. While traffic sources provide data on how their audience is interacting with an ad, their platforms are not designed to help advertisers improve other areas of the sales process (such as optimizing the website to improve conversion rates). Through the association of items that the system provides, optimizations can occur on the traffic source based on data that is otherwise unknown to them.

For example, tracking platforms may know the average “time on site” spent by visitors. A user may define an optimization rule that pauses “placements” in a traffic source that have an average time spent by its visitors below a certain threshold (implying possibly uninterested traffic). Rather than relying on a certain “spend” for each placement before optimizing it, an advertiser could use the average time spent by its visitors as an earlier indicator of interest to block it.

Campaign setup may optionally be performed as described with regard to the various exemplary web based interfaces of FIG. 3, which are non-limiting examples of screens for the previously described user interface.

The “items” (subids/parameters) fetched from the tracking platform are matched with those of the traffic source to permit optimizations, as described for example with regard to FIG. 3E, despite any naming inconsistencies. For example, a user may call the website on which an ad was served “site” in their tracking platform; whereas a traffic source calls it “placement”. Based on the commonality of item values (such as both containing “games.com”), the misnamed items can be matched to permit optimizations. Further, a user can reconfirm or manually specify the connections, as described for example with regard to FIG. 3F. These relationships between the tracking platform and traffic source items are then stored into the database 110 (shown in FIG. 1).

Certain non-user defined items that are common between the campaign's tracking platform and traffic source would always exist in the system. For example, if the selected tracking platform and traffic source provide breakdowns for “devices” or “mobile carriers”, they would be provided as an option for campaign rules in Step 342.

FIG. 4 describes various methods for gathering and logging reports, for example and without limitation for gathering performance and spend data, from the tracking platforms and traffic sources respectively. FIG. 4A shows an exemplary overview of the workflow for gathering and logging reports. FIG. 4B shows a detailed workflow for gathering and logging reports. FIG. 4C shows a detailed workflow for retrieving/storing “items” and their relationships. FIG. 4D shows a detailed workflow for fetching item reports by intervals.

Turning now to FIG. 4A, a non-limiting, exemplary method is shown for Retrieving/Storing Data. There are various non-limiting examples of ways to do this, for example according to one or more of obtaining the list from platform, obtaining only those items from source API, or retrieving all possible data according to matched intervals. A Process 400 begins with defining the intervals for partial or complete data retrieval in Step 402.

These intervals support obtaining data in blocks defined by the “frequency” with which the user wants to optimize their campaigns, which in turn supports the previously described events, according to which optimization is estimated and impact is determined. For example, if a user wants to optimize their campaigns hourly, performance and spend data is fetched for each hour and stored. Similarly, it would be fetched for each day and stored if the user was optimizing their campaigns daily. This unique approach is critical to the process of Retroactive Optimizations, as the smaller blocks permit the application of impact multipliers to the sum of the performance metric prior to the event's time.

Persistently running scripts check whether any campaigns are due for the fetching of reports. If so, all items for the campaign are fetched from the tracking platform using the relevant APIs. The system logs any new items to the database. It also matches any previously unmatched tracking platform items that are now matched with the traffic source items by the user.

While possible, it would be unnecessarily resource intensive to fetch reports at a greater speed than the campaign optimization frequency. For example, if the campaign is only being optimized hourly as per the specified optimization frequency, querying the tracking platform and traffic source APIs every few milliseconds would be excessive. Instead, the reports may be fetched for every hour, with the events' time being restricted to the hour as well.

In a particular embodiment, for each campaign optimization frequency interval (such as “hourly”), the performance and spend metrics for each item value (such as “games.com” for item “placements”) are matched to be stored in the database 110 in Step 420, based on the item relationships defined in Step 350 (FIG. 3E). As the items are matched in the “Campaign Setup” phase [described with regard to FIG. 3E], naming inconsistencies between the tracking platform and traffic source items do not matter. Each unique item value (such as “games.com”) is stored in a table; and the resulting unique item ID is referenced in the reports when the performance and spend metrics are gathered for every optimization frequency interval and stored. If the status of any item value is detected to have changed from the reports (such as the placement “games. com” being paused in the traffic source), an “event” is automatically created with the estimated impact as shown in Process 400, which is the same as Step 208 (FIG. 2). How the impact of an event is calculated in Step 208 is explained subsequently.

In FIG. 4D, getTrackerReports( ) function is used. This function would contain the APIs of all supported tracking platforms to fetch reports—and the relevant one used based on the tracking platform of the campaign being optimized. It would also accept as inputs the criteria for the report; such as the interval of the reporting period, and the item for which the report should be fetched (such as “devices”). In so doing, getTrackerReports( ) function would attain reports in a standardized format for the system to use, irrespective of the tracking platform being used.

### Item Hierarchies & Relationships:

A system and method are provided for taking into account the relationship of items when optimizing ad campaigns. Every optimization has an impact on the performance of other items. For example, pausing underperforming “ads” may increase the ROI sufficiently, such that pausing underperforming “devices” is no longer necessary (given the increase in its ROI from pausing the underperforming ads). It follows that the order in which items are optimized also matters.

To illustrate the above example, assume a campaign has a 20% ROI goal and has a $100 spend between desktop and mobile devices. The spend can be categorized as shown in FIG. 4E.

If Ad #2 is paused, the campaign's ROI would improve approximately to 28.29%, as shown below:

ROI Δ=({active items' ROI}−{active items'+pausing items' ROI})/{active items' ROI+pausing items' ROI}

=({active items' profit}/{active items' spend}−{active+pausing items' profit}/{active+pausing items' spend})/[{active+pausing items' profit}/{active+pausing items' spend)]

=[($2.5+$18.75+$10.5)/($25+$25+$25)−($2.5+$1.25+$18.75+$10.5)/($25+$25+$25+$25)]/[($2.5+$1.25+$18.75+$10.5)/($25+$25+$25+$25)]

≈˜28.28%

If Ad #1 is paused, the campaign's ROI would improve approximately to 38.19%, as shown below:

ROI Δ=[($18.75+$10.5)/($25+$25)−($2.5+$18.75+$10.5)/($25+$25+$25)]/($2.5+$18.75+$10.5)/($25+$25+$25)

≈˜38.19%

Now, if a user was optimizing each item in isolation, the user may pause the desktop devices since their performance would fall below the 20% ROI goal. As a result, the user would lower the target market/traffic volumes because the pausing devices would exclude an audience segment.

However, if the user was to approximate the impact of pausing underperforming Ad #1 and Ad #2, the ROI of the desktop devices should theoretically improve to approximately 26.59%, as shown below:

Desktop ROI=15%×1.(28.28%) from pausing Ad #2×1.(38.19%) from pausing Ad #3

≈˜26.59%

The above example illustrates how a user may unnecessarily pause an item when attempting to optimize a campaign.

In addition to the above example, the relationship and intertwined “impact” of optimizing items should be taken into account to prevent prematurely taking actions. It follows that the hierarchy in which optimizations occur also matters. For example, if devices were optimized first in the above example, certain ads' ROI may have improved sufficiently to not warrant pausing. Similarly, FIG. 4F shows that removing Page #1 from rotation would improve the campaign—and all dependent items' ROI—by 20% as well. It may thus not be necessary to pause certain lower performing dependent items, if the anticipated impact of removing Page #1 is taken into account.

In a particular embodiment, the system accounts for this by optimizing in order of the provided rules. Thus, if a user wants a campaign's placements optimized before devices, the placement-specific rule would be listed first. As each preceding rule's optimization occurs, the “event” and resultant impact would be logged (discussed later) for subsequent rules to consider. In so doing, a user can specify a hierarchy based on the order of optimization rules.

The system has the capacity to determine the ideal optimization hierarchy without user input. Advertisers may make poor decisions by not properly evaluating the impact of lowering bids or pausing items on dollar profits. The system could thus optimize items based on the user's objectives automatically; such as optimizing items that have the lowest dollar profits first, so that ones with higher profits are only altered once the other optimization options are exhausted. Such automated ordering is pivotal when sorting post-event data of item values for optimization as described with regard to FIG. 2. In that case, the user can, for example, define whether item values with the lowest/highest spend/profit/visits should be optimized first.

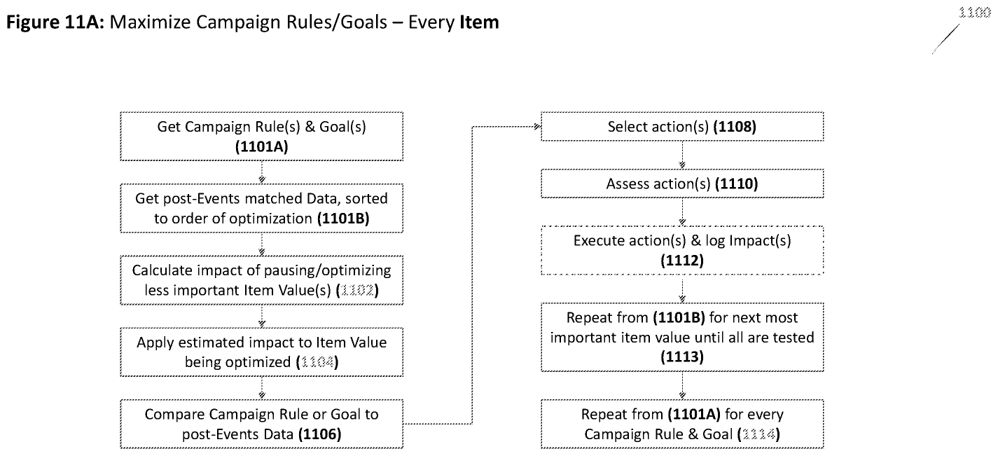

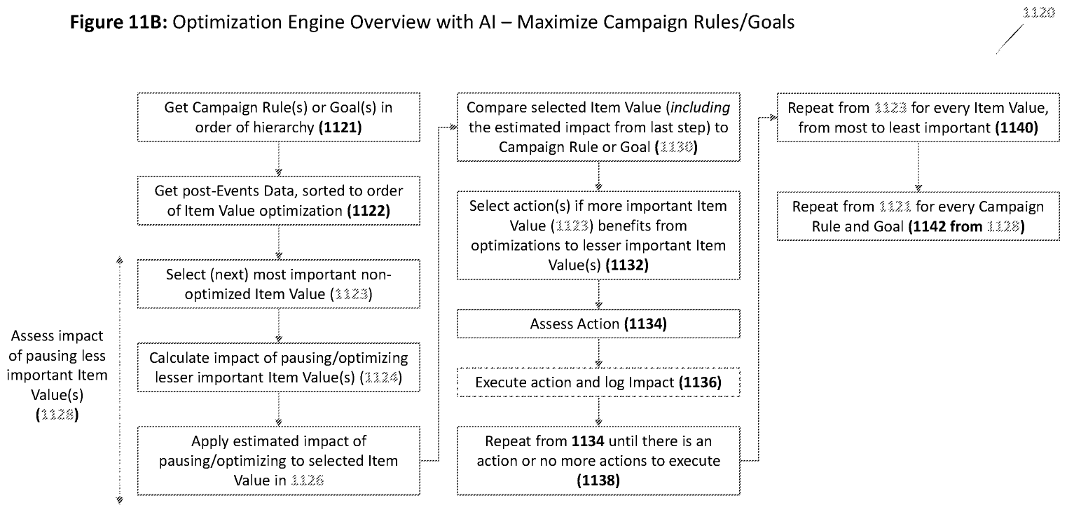

It could also pause less important items that are satisfying targets, in order to improve the ROI of a more important item. In a particular embodiment, doing so would simply be a matter of scanning items that are lower in the optimization hierarchy, and pausing them if it improves the performance of a more critical item sufficiently to keep it active, as shown for example in FIGS. 11A and 11B.

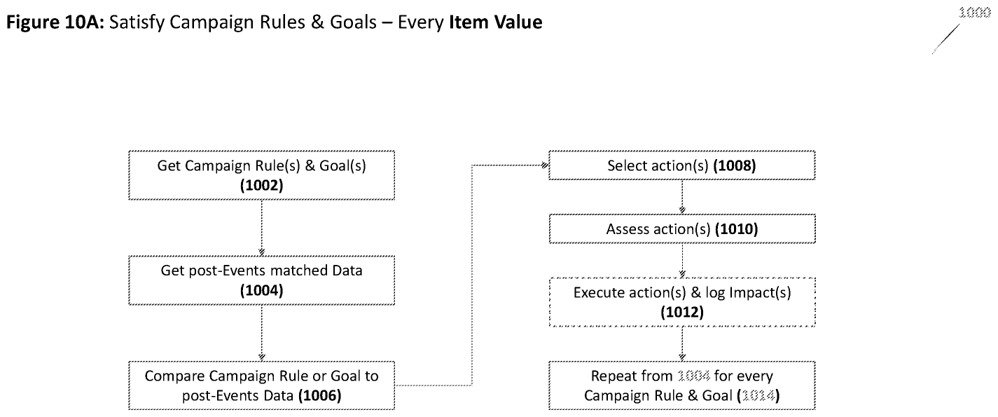

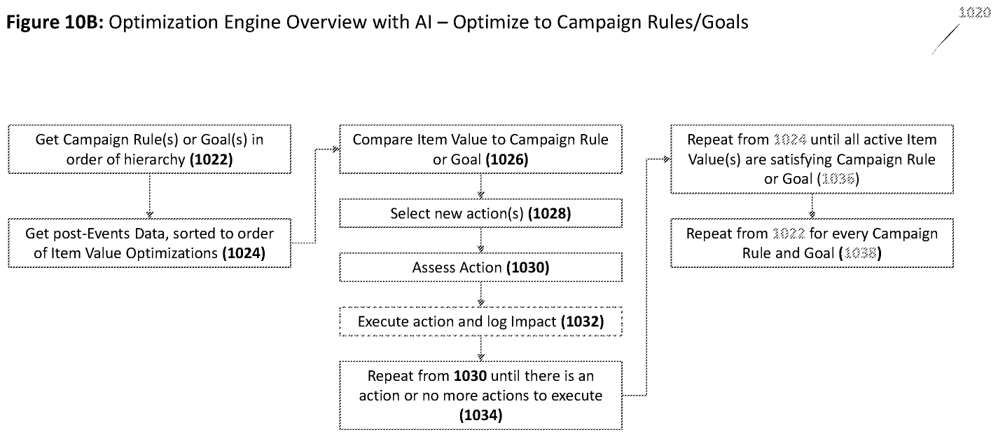

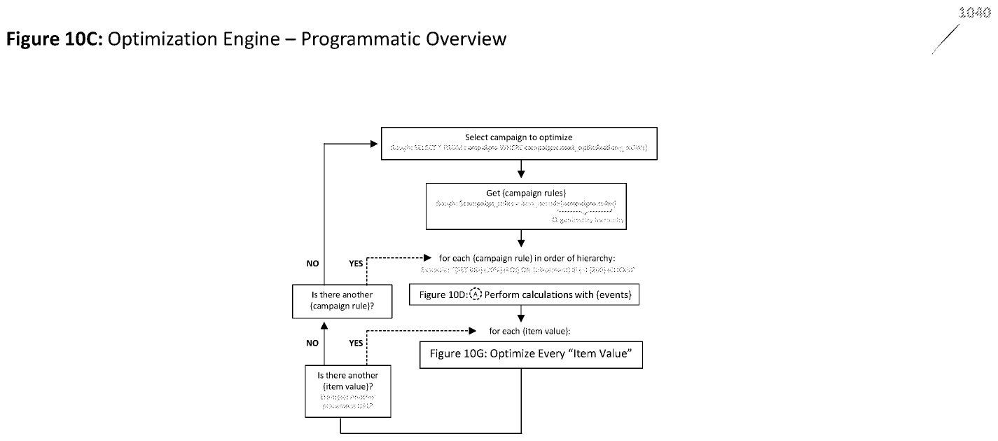

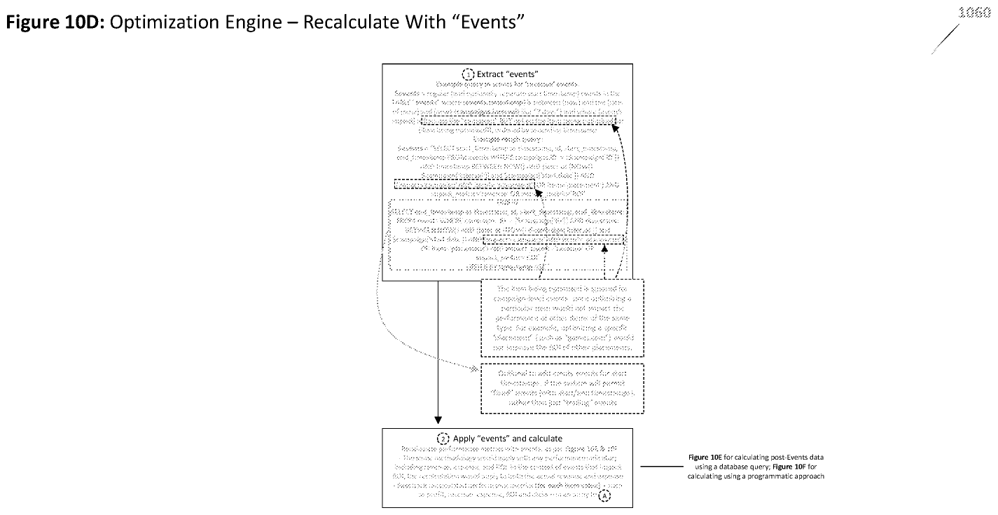

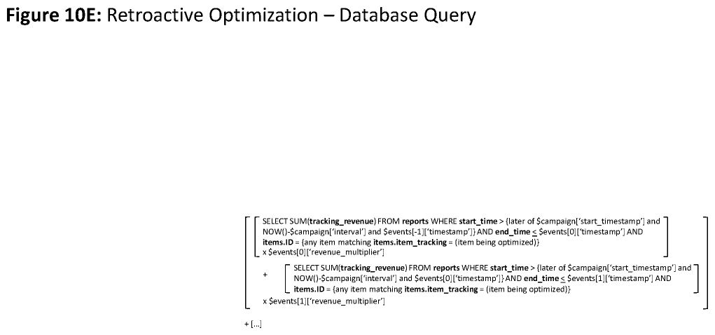

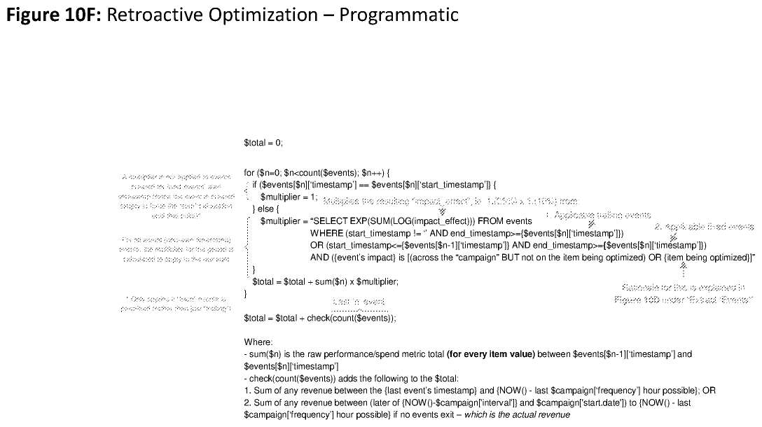

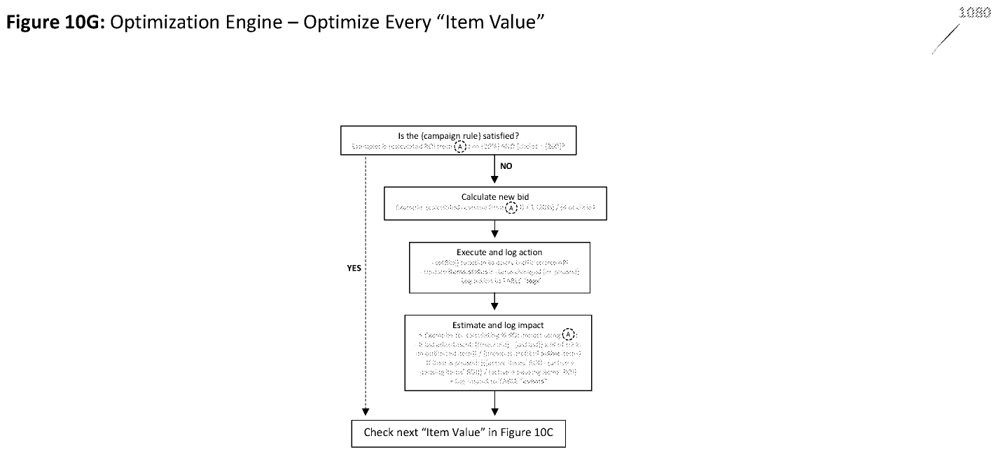

The system is also able to account for the fact that optimizations to a particular item value do not impact the performance of other item values of the same type. For example, pausing “games.com” would not directly impact the performance of other placements (since they are independent), but it would alter the performance of other items—such as the ads and landing pages—that were being impacted by “games.com”, as shown for example with regard to the impact of events in FIG. 10D.

### Events:

A system and method is provided that estimates and logs the “impact” of various campaign optimizations. The “events” can be automatically detected by the system (based on changes made or detected in the tracking platform and traffic source) as previously described, and/or be manually specified by users, as shown for example in FIG. 7A (manual user specification) and FIG. 7B (impact of such specification).

Previously, it was impossible for online advertisers to immediately apply the impact of various optimizations on all other items. After performing optimizations, advertisers would analyze data from the point of optimization onward to account for the impact. This approach is impractical and inefficient when campaigns are constantly being optimized. Alternatively, advertisers would continue optimizing campaigns based on historical/trailing data. However, since the amount of new data would be too insignificant to outweigh the pre-optimization historical data, advertisers would be optimizing based on outdated data under this approach. Further, these traditional approaches make it impractical to gauge the impact of smaller optimizations, such as routine bid adjustments.

Using a novel process called “Retroactive Optimization” that is explained later, the impact of (optimization) events is taken into account retroactively and immediately, rather than constantly having to wait for data anew after every optimization. For example, assume a lower performing version of a website is eliminated from rotation (which will increase revenue by 25%). A “trailing event” would immediately be created that applies a +25% “multiplier” to all revenue prior to that time for calculations. The multiplier is only applied to the performance/spend metrics prior to the event's timestamp, since the impact of any optimization would already be reflected in the metrics thereafter.

The impact of most events can be applied on a “trailing” basis; that is, the impact of the optimization is applied to all metrics prior to the event. As will be shown when discussing the application of “weights” later, creating “trailing events” to indirectly apply impact multipliers between specific start and end timestamps (rather than to everything prior to an event) can be conceptually challenging. Thus, a particular embodiment of the system permits separate “fixed events”, which have a defined start and end timestamp to which the impact of the optimization applies.

It should be noted that the novel events-based methodology may be applied to increase the efficiency of the traditional optimization approach as well. For example, once a certain threshold is met after an “event” (such as clicks received on the optimized item), the data before and after the event could be compared to analyze the impact. The system can then update the event's impact in the database 110; thus allowing other items to take the updated impact into account during optimizations. Further methodologies to determine the true impact of previous optimizations, by removing the impact of other optimizations, are discussed later with regard to the process to monitor the direction of previous optimizations.

### Retroactive Optimization:

A system and method are provided that applies “events” retroactively; such that the impact of these optimizations is considered immediately when optimizing other items.

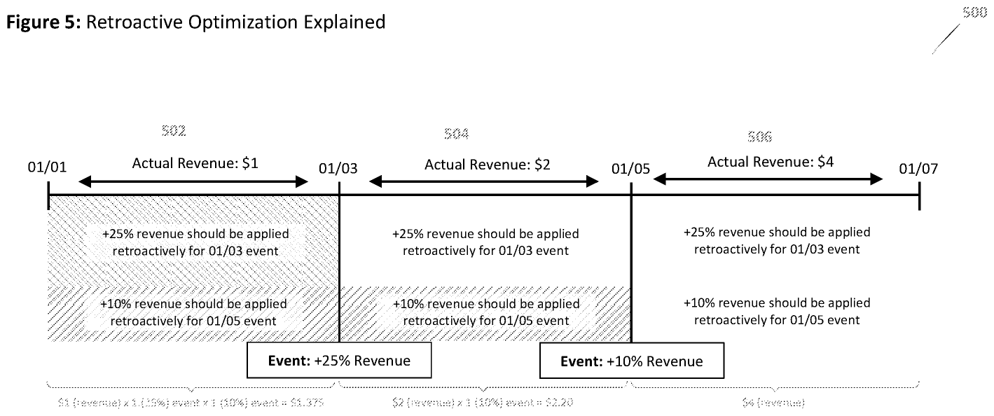

FIG. 5 shows a rationale and explanation of “Retroactive Optimization.” As an illustration for a process 500, a campaign timeline is assumed to have dates ranging from 01/01 to 01/07, which is equally divided into 3 parts where a 01/03 event occurs to increase revenue by 25% and a 01/05 event occurs to increase revenue by 10%.

During part 1 from 01/01 to 01/03 (502), the campaign's actual revenue is $1. If the campaign is being optimized on 01/03, it should take into account the event that increases revenue by 25%. Rather than calculating the bid amount based on the actual revenue of $1 over the prior period, it should be based on $1.25 ($1 actual revenue×1.25 multiplier).

During part 2 from 01/03 to 01/05 (504), the campaign actual revenue is $2. The revenue is expected to increase another 10% based on the 01/05 event. Thus, if the campaign is being optimized on this date, revenue on which to base the bid should be calculated as follows:
$1.25 for the period prior to 01/03, as calculated previously. Applying another 25% revenue multiplier on the revenue after 01/03 is unnecessary, as the impact of the 01/03 event (optimization) would already be effective in the actual revenue from that point onward.
However, the $1.25 revenue calculated prior to 01/03 should be multiplied by 1.10 to account for the 01/05 event that is expected to increase revenue by 10%. Thus, the calculated revenue for the period prior to 01/03 would be $1.375 ($1.25 calculated previously×1.10 multiplier).
For the period 01/03 to 01/05, the actual revenue of $2 should be multiplied by the effective 10% revenue multiplier for an estimated retroactive revenue of $2.20 after the event ($2 actual revenue×1.10 multiplier).
The total revenue to be used for optimizations (after taking into account the events) should thus be ˜$1.38 for 01/01 to 01/03+$2.20 for 01/03 to 01/05, for a total of ˜$3.58 rather than the actual revenue of $3.00.

During part 3 (506), the campaign actual revenue is $4. Since no events exist after 01/05, a multiplier need not be applied to the actual revenue of $4 thereafter. The total revenue used for calculations would thus be $7.58 (˜$1.38 for 01/01 to 01/03+$2.20 for 01/03 to 01/05+$4 for 01/05 to 01/07).

FIG. 6 shows an overview of a non-limiting, exemplary process for Retroactive Optimization, including the application of “Events” to data. For the exemplary process 600, the timestamp for each event is obtained at Step 602. Next, the actual data is obtained from the database at Step 110 between the last event's timestamp and current. After obtaining the actual data, it is multiplied with the Compounded Impact Multiplier of events at Step 604. Then, the product of the multiplication is added to the running total at Step 606. Afterward, at Step 608, each step (110, 604, 606) is repeated for every “Event” time period obtain in Step 602. The final total is the Post-Events Data (after taking raw data and applying Impact Multiplier to it), wherein the final total equals the running total for the last event.

The non-limiting, exemplary optimization process, described in more detail in FIG. 6, can be summarized into a mathematical equation called the “Retroactive Optimization Formula”, which may be described as an application of events to data. In its simplest form, as an example, the methodology is:

f(c)=>[sum(n)×multipliers(n)]|n=0 to ‘c’, and wherein:
‘n’ is the event number in the $events array (starting from 0)
‘c’ is the number of total events: count($events-1)
sum(n) is the raw performance/spend metric total (for every item value) between $events [n-1][‘timestamp’] and $events [n][‘timestamp’]
multipliers(n) is the compounded impact of all events that apply between $events[n-1][[‘timestamp’] and $events[n][‘timestamp’]
A filler/marker event (with no impact multiplier) can be added to “events” with a timestamp that correlates with the end of the period being analyzed. This is comparable to the filler/marker events for the “start” timestamp of fixed events. The filler/marker events force the addition of the sum between the last event's timestamp and the end of the period being analyzed

At its core, “Retroactive Optimization” entails extracting performance/spend sums for various intervals based on the timestamp of “events”. Then, for each of these intervals, the compounded impact of all applicable events is applied to it via a multiplier. The total of these events' intervals after applying the multipliers is used in determining whether or not “rules” are satisfied during optimizations—termed “post-events data”. This differs from relying on the “raw” performance/spend sums that do not immediately take into the account the impact of optimizations.

When using fixed start timestamps, a separate “filler” event may be created (even though there is no “multiplier” impact to be applied by the start timestamp event). This forces the following event to only calculate from the start timestamp, so that the fixed timestamp event's impact multiplier can be correctly applied. Thus, when fetching events from the database, an extra event is added to the $events array if one with a start timestamp is detected.

For example, turning back to FIG. 5, assume a fixed event that applies a +20% revenue multiplier from 01/02 to 01/04. The $events array would contain two events for this; one at 01/02 with no impact multiplier, and another at 01/04 with a +20% revenue multiplier. The presence of the 01/02 would force the system to perform a calculation of the revenue from 01/01 to 01/02 with applicable events. For the 01/03 event then, the calculation would be performed for the period from 01/02 (since an event was created for the fixed event's start timestamp) to 01/03; thereby, accurately applying the +20% revenue multiplier for the fixed event from 01/02 onward, in addition to the +25% revenue trailing event's impact on 01/03 with no start timestamp.

Under the preferred Direct Approach, every campaign optimization's estimated impact is logged as an “event”. This may, however, be computationally expensive if bid adjustments are treated as events as well. To address this concern, a less accurate Indirect Approach may be used; either in isolation, or in combination with the Direct Approach for specific items and types of optimizations. With the Indirect Approach, a performance metric (such as profit) of active/adjusted items is extrapolated to the overall item (which would include paused items), based on a common spend criteria (such as spend or clicks)—which is then compared with the item's overall performance to gauge the impact of optimizations. The indirectly calculated impact of optimizations (“Differential”) is then used as a multiplier in other items' optimizations. Both Direct Approach and Indirect Approach are described below in greater detail.

“Events” are also used in Retroactive Optimizations to apply weights based on the age of the data. As in a previous example, assume that a campaign has 2 hours of data with equal spend in each hour, and the user wants to apply a 60% weight to the second (more recent) hour. When the system only supports “trailing events”, two events can be created to apply these weights. At the time of optimization, the first event reverses the 60% weight that will be applied subsequently, and applies a 40% weight to the initial hour instead [calculated as (1/60% weight)×40% weight]. The event applying a 60% weight will thus only impact the second hour. If the campaign has $120 in revenue for the first hour, and $140 in revenue for the second hour, the revenue used for optimizations would be $264<{[$120 first hour×(1/60%×40% multiplier)]+$140 second hour}×60% multiplier×2 weights>.

In a preferred embodiment, “fixed events” are treated differently from “trailing events” to apply weights. This may be conceptually easier for users to understand. In this embodiment, a separate filler/marker event (with no impact multiplier) for each “start timestamp” is added to the list of “events” that are used in the Retroactive Optimization calculations. These filler/marker events force a calculation between the previous event and the start timestamp of the fixed event, such that the fixed event's impact is accurately applied to the correct period from then onward.

Similarly, a filler/marker event with no impact multiplier can be created for the end of the campaign period being analyzed for optimizations, rather than a check(n) function as in some iterations of the Retroactive Optimization Formula presented. This no-impact event would force the addition of the performance/spend metrics' sum between the actual last event (which has an impact multiplier) and the end of the campaign period being analyzed.

Returning back to the example describing FIG. 5, the Direct Approach can be depicted in a query, an example of which is shown in FIG. 10E. The database query to sum the tracking revenue can further be summarized as follows:

sum(n)=SELECT SUM(tracking_revenue) FROM reports WHERE start_time>{later of $campaign[‘start_timestamp’] and NOW( )-$campaign[‘interval’] and $events[n-1][‘timestamp’]} AND end_time≤$events[n][‘timestamp’]

AND items.ID={any item matching items.item_tracking=(item being optimized)}

where:
‘n’ is the element (event) number in the $events array being used
‘n-1’ in $events[n-1][‘timestamp’] indicates that the end of last event is the start time of the next event

In the previous examples, there would be more events in the $events array than the applicable events in the database 110 (shown in FIG. 1). As noted previously, this is due to a separate event being created for the start timestamp of “fixed” events in the $events array; thereby forcing the system to correctly apply the fixed item's impact from its start timestamp onward.

In a recursive formula, the Retroactive Optimization that applies events can be achieved as follows:

f(−1)=0;

f(n)=[f(n-1)+sum(n)×fixed_multiplier(n)]×trailing_multiplier(n)+check(n); for n≥0,

n<count($events) where:
‘n’ is the event number in the $events array (starting from 0)
sum(n) is the raw performance/spend metric total (for every item value) between $events[n-1][‘timestamp’] and $events[n][‘timestamp’]
trailing_multiplier(n) is the multiplier for an event ‘n’ that has a trailing impact (does not have a fixed “start_timestamp”)
fixed multiplier(n) is the compounded impact of all fixed events (have a “start_timestamp”) that apply between $events[n-1][[‘timestamp’] and $events[n][‘timestamp’]
Example of applicable fixed events: (start_timestamp<={$events[n-1] [‘timestamp’]} AND end_timestamp>={$events[n][‘timestamp’]})
If the event ‘n’ is one created to account for an event's start timestamp, a multiplier of 1 is applied
check(n) is a function that runs once if ‘n’ is the last event [count($events-1)] to add the non-multiplier performance/spend sum after it

With a total of 3 events, the above recursive formula would be expanded as follows:

f(3)=<{(0+sum(0)×fixed_multiplier(0))×trailing_multiplier(0)+sum(1)×fixed_multiplier(1)]×trailing_multiplier(1)+sum(2)×fixed_multiplier(2)}×trailing_multiplier(2)+sum(3)×fixed_multiplier(3)>×trailing_multiplier(3)+check(3)

=sum(0)×fixed_multiplier(0)×trailing_multiplier(0)×trailing_multiplier(1)×trailing_multiplier(2)×trailing_multiplier(3)

+sum(1)×fixed_multiplier(1)×trailing_multiplier(1)×trailing_multiplier(2)×trailing_multiplier(3)

+sum(2)×fixed_multiplier(2)×trailing_multiplier(2)×trailing_multiplier(3)

+sum(3)×fixed_multiplier(3)×trailing_multiplier(3)+check(3)

In an explicit formula, the above Retroactive Optimization that applies events can be achieved as follows:

f(c)=sum(n)×fixed_multiplier(n)×trailing_multiplier(n), . . . , x trailing_multiplier(c)+check(n)|n=0 to ‘c’,

where:
‘n’ is the event number in the $events array (starting from 0)
‘c’ is the number of total events: count($events-1)
trailing multiplier(n, . . . , c) is the multiplier for each trailing impact event (does not have a fixed “start_timestamp”)
fixed_multiplier(n) is the compounded multiplier of all fixed events (have a “start_timestamp”) that apply between $events[n-1][[‘timestamp’] and $events[n] [‘timestamp’]
Example of applicable fixed events: (start_timestamp<={$events[n-1] [‘timestamp’]} AND end_timestamp>={$events[n][‘timestamp’]})
If the event ‘n’ is one created to account for an event's start timestamp, a multiplier of 1 is applied
check(n) is a function that runs once if ‘n’ is the last event [count($events-1)] to add the non-multiplier performance/spend sum after it

In its simplest form then, the Retroactive Optimization that applies events can be defined as:

f(c)=Σ [sum(n)×multipliers(n)]n=0 to ‘c’,

where:
‘n’ is the event number in the $events array (starting from 0)
‘c’ is the number of total events: count($events-1)
sum(n) is the raw performance/spend metric total (for every item value) between $events[n-1][‘timestamp’] and $events[n][‘timestamp’]
multipliers(n) is the compounded impact of all events that apply between $events[n-1][[‘timestamp’] and $events[n][‘timestamp’]
A filler/marker event (with no impact multiplier) can be added to “events” with a timestamp that correlates with the end of the period being analyzed. This is comparable to the filler/marker events for the “start” timestamp of fixed events. The filler/marker events force the addition of the sum between the last event's timestamp and the end of the period being analyzed

As noted in the last simple Retroactive Optimization formula, if a separate event is created in the $events array for the timestamp until which the campaign is being analyzed, a check(n) function is unnecessary.

While the above examples pertain to a revenue-based event, the same process will be used by the system across any performance and spend indicator; including, but not limited to, events that impact return-on-investment (ROIs), expense, or click-through rates (CTRs). If an event impacts the ROI, the multiplier would impact both the revenue and expense sums to attain the desired impact retroactively.

Turning back to FIG. 5, it is possible to update the impact of the 01/03 event after actual data is gathered. For example, if it is determined that the 01/03 actually improved revenue by 30% (void of any other events), the event's impact can be updated to be “+30% revenue” for subsequent calculations. This is not ideal, as multiple optimizations may be occurring before confidence in an event's data is achieved; thereby reducing accuracy of the optimizations.

It is possible to perform calculations from an event onward (optionally, once sufficient data has been gathered). For example, the data prior to the 01/03 event can be completely ignored, and optimizations would be performed once sufficient data has been gathered subsequent to the event. This is not ideal, as it would likely involve achieving statistical significance after every event; but is nonetheless possible within the scope of this system.

A methodology that incorporates “fixed events” is presented (based on a start and end time), rather than always applying events to all revenue prior to the event. While this may be applicable if the system is calculating the impact of an item that was started and paused within the period being analyzed, in principle, it is likely unnecessary. If an item is paused, an “event” is already created that indirectly incorporates the span over which the item ran, by comparing the profit of the paused item against other active items to gauge impact. Similarly, as discussed previously, “weights” can be applied to data via trailing events as well.

In another embodiment, using the Indirect Approach, the “impact” of optimizations can be indirectly calculated across the entire item, rather than calculating and logging the optimization impacts of individual item values. For any given item (such as “placements”), the performance metrics of “active” (or “adjusted”) item values may extrapolated ($20 profit of active placements over $50 spend for a 40% ROI), and then compared with the total performance of the overall item ($10 profit of all placements over $100 spend for a 10% ROI) to gauge the impact of optimizations [300% ROI improvement/multiplier calculated as (40% new ROI−10% old ROI)/10% old ROI]

Similar to the preferred embodiment, the impact of all other items' optimizations is used as a multiplier when performing calculations retroactively. However, rather than having to “estimate and log impact” for individual items after every optimization (as is the case in FIG. 2), the differential between active/adjusted and overall items is used as the multiplier for other items' calculations.

In this embodiment, a performance metric (such as profit) of active/adjusted items is extrapolated to the overall item, based on a spend criteria (such as spend or clicks). Then, the extrapolated performance metric is compared with the item's overall performance to gauge the impact of optimizations. This could further be used with “events” to incorporate other optimizations that would be overlooked by the methodology, such as post-sale optimizations that improve customers' lifetime value.

To accommodate this approach, the automated “estimate and log impact” items can be removed to simplify the system. The multiplier(n) function in the Retroactive Optimization Formula can be modified to take into account the active and overall item “Differential” in several ways; two of which are presented below:
a) If multiplier(n) for item differentials is calculated at the time of each event's calculation, the modified multiplier(n) function would be:

multiplier(n)=multiplier for event ‘n’ (ie. +25% revenue would be a 1.25 multiplier; same as direct approach)*impact of changes made to the campaign (“Differential”), wherein:
‘n’ is the event number in the $events array (starting from 0)
extrapolator(n) is calculated as: Σ{spend metric across the entire item}/Σ{spend metric of “active” or “adjusted” item values}
Performance/spend metrics are fetched from the last event's date [“date(n-1)”] until the current event's date [“date(n)”]
Performance metrics could be items such as revenue or profit; while spend metrics could be expense or clicks/impressions
More specifically:

multiplier(n)=multiplier for event ‘n’*[(Σ{performance metric of “active” or “adjusted” item values}*extrapolator(n)−Σ{performance metric of entire item})/Σ{performance metric of entire item}]
b) If multiplier(n) for item differentials is calculated after all events' calculation, the modified function would execute once after the last (“n”) event. In this case, the Differential would only be calculated once to the entire campaign period being analyzed, after the last (“n”) event's multiplier is applied. As such, the “where” clause in the prior equation for the reporting period would change to the following: “Performance/spend metrics are fetched from the start of the campaign until the end. Stated differently, the period for the reports would be (later of NOW( )-$campaign[‘interval’]} and $campaign[‘start.date’]) to {NOW( )-last $campaign[‘frequency’] hour possible}”

As shown, the Differential's application can be customized in many ways. It is used as an additional “multiplier” to take into account the indirect impact of optimizations made to the campaign. The user or platform then has the ability specify which optimizations are logged as “events” for explicit impact calculations; and which can be attributed to the Indirect Approach method for indirect impact calculations at the end.

Optionally, unlike the preferred Direct Approach, the Indirect Approach extrapolates the performance of active/adjusted item values. It follows that the Indirect Approach would overlook optimizations that were unrelated to the pausing of items. Nevertheless, the novel Indirect Approach falls within the realm of the optimization methodology. A variation in which the Indirect Approach can be implemented is summing unpaused item values from drill-down reports in tracking platforms, and extrapolating it over the entirety of the item, to calculate estimated impacts.

Both FIGS. 7A and 7B deal with client inputs. Specifically, FIG. 7A shows a sample webpage where a user can define “events” and their impacts manually. In the sample, the user selects a campaign from a “Campaign” dropdown list containing all of the user's campaigns. After selecting a campaign, the user selects an item from “Item” dropdown list that triggered the event, which is dependent on the user's campaign selection. If the manual event impacts specific item(s) only, the user can optionally define it. The user can then click the “Save” button to manually create the event.

FIG. 7B shows an overview of the steps after an “event” is manually created. Based on the user's inputs from FIG. 7A, the system checks whether an “event” that the user created would already have been detected by the system to avoid duplication of events. The system starts by first checking if a manual event's action would have been created automatically. If the answer is “Yes” and the impacted item's status matches an automatically created one, then the system deletes the automatically created impact. Afterwards, the system checks if the impact is manually provided. (In the case the answer is “No”, the system would have proceeded to the same step of checking if the impact is manually provided.) Based on this check, if the check returns “Yes”, the system creates a new event with the provided impact. If “No”, the system creates a new event with the impact estimated by the system.

The following example illustrates the above steps. The system checks for events automatically, like an ad being paused, and creates an event in the system; if the user then creates an event for the ad being paused, it will be a duplicate. The system will prevent duplicate events, by typically overriding the automatically created event with the user-specified one.

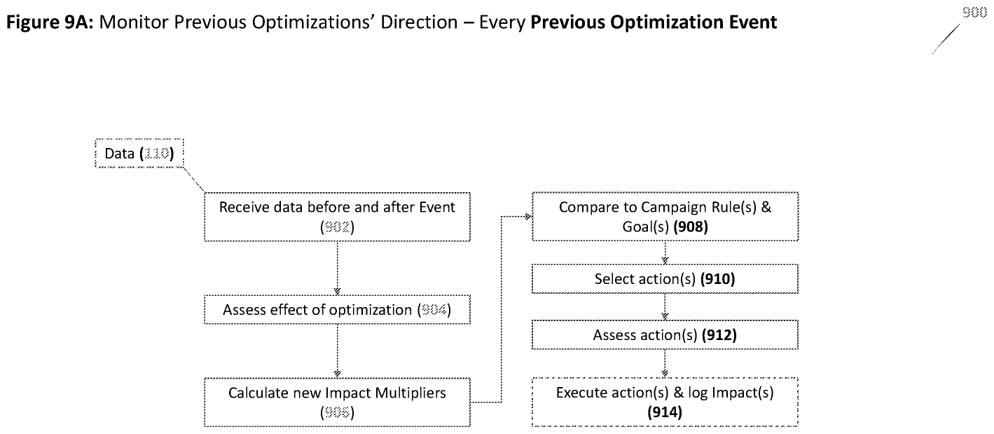

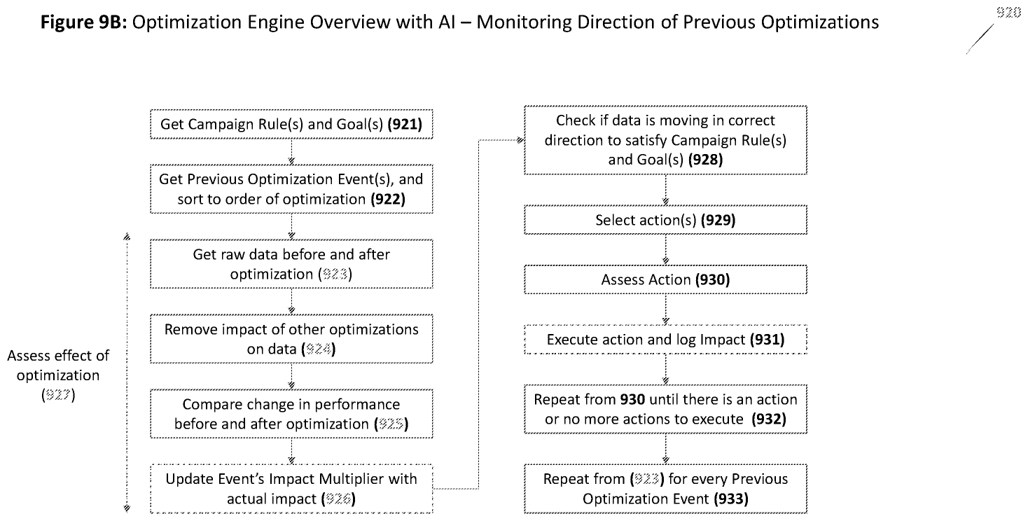

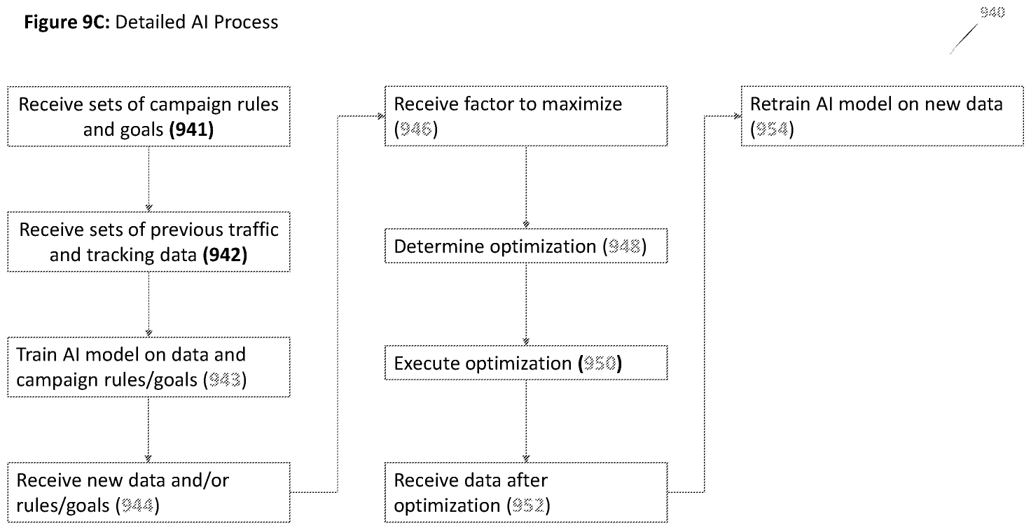

Non-limiting examples of ongoing optimizations are provided with regard to FIGS. 8-12. FIG. 8 shows a non-limiting exemplary method for optimizing campaigns in various ways to satisfy specified campaign rules and goals, after retroactively accounting for the impact of “events” in calculations. FIG. 8 combines the various steps of each optimization methodology explained later in FIGS. 9-12, to show their common elements. The campaign for optimization may optionally be selected according to the method described in FIG. 3. In each optimization methodology for the selected campaign, the rules and goals are first obtained [802]. Based on the selected campaign rule or goal, the relevant data is obtained for the item value(s) or event(s) [804]. In some optimization methodologies, this may be the post-events data, after applying the impact of various events. The data may also be sorted to the order of the optimization; for example, sorting item values from least revenue to the most (or vice versa). In that case, item values with the least revenue may be paused/optimized first—so that the more important item values benefit from the lesser ones' optimizations. Next, the specific step(s) unique to each optimization methodology are performed [806]. For example, and as explained later, when assessing the direction of previous optimizations, this may entail removing the impact of other optimizations [927]. Similarly, when optimizing to maximize the campaign rules and goals, the optimization-specific step would be assessing the impact of pausing less important item value(s) on the more important one [1128]. When re-assessing paused items, the optimization-specific step would be testing the paused item value(s) against all campaign rules and goals before selecting an action [1231], rather than the approach in other optimization methodologies wherein all item values are tested against a single campaign rule or goal at a time (in order of hierarchy). In all optimization methodologies, the processed data is compared to the campaign rule(s) and/or goal(s) [808], on the basis of which actions are selected [810]. These actions are then assessed [812], and executed/logged if they have not failed previously [814]. If the action has previously failed, another action is selected, unless there are no more possible actions to execute [816]. The process is repeated from 804 for the next item value, or the next optimization “event” when the optimization pertains to monitoring the direction of previous optimizations [818]. The system then optimizations for the next most important campaign rule or goal from 802. However, the system does not repeat from 802 when the optimization pertains to monitoring the direction of previous optimizations, or re-assessing paused items. For these, the system already checks the previous optimization event or paused item value against all campaign rules and goals on their respective optimization-specific steps.

Based on the Retroactive Optimization methodology discussed previously, the system recalculates metrics using the applicable events (“Post-Events Data”) to use in optimizations. For example, if an event occurred that increases revenue by 25% on January 1st, a 1.25 revenue multiplier would be applied for the sum of revenue until that date. Subsequently, if another event occurred that increases revenue by 10% on January 15th, a 1.10 revenue multiplier would apply to the post-event calculated revenue until that date; being the pre-January 1st revenue multiplied by 1.25, plus the normal revenue from January 1st to 15th (that now includes the impact of the first event), multiplied by a 1.10 multiplier from the January 15th event. In a preferred embodiment, the metrics recalculated with the impact of events—such as profit, revenue, expense, ROI, and clicks—would be used to determine whether campaign rules are satisfied (rather than the “raw” metrics that do not immediately account for the impact of optimizations). In all subsequent optimizations, this post-events data would be used when making optimization decisions.

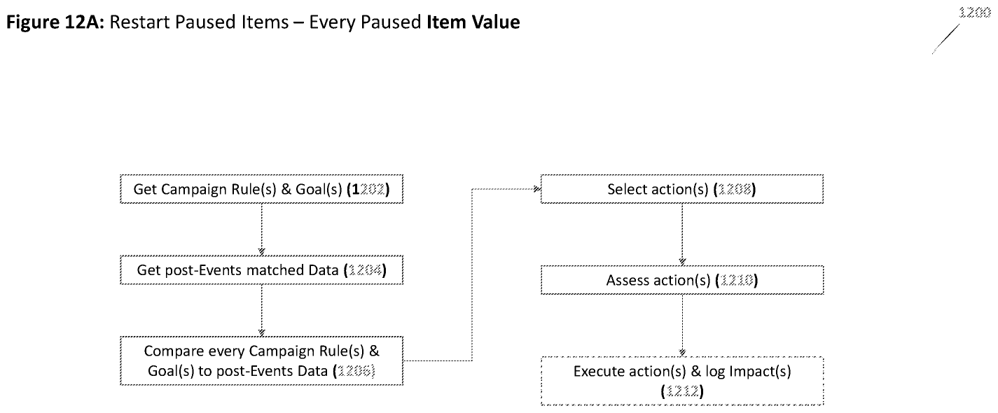

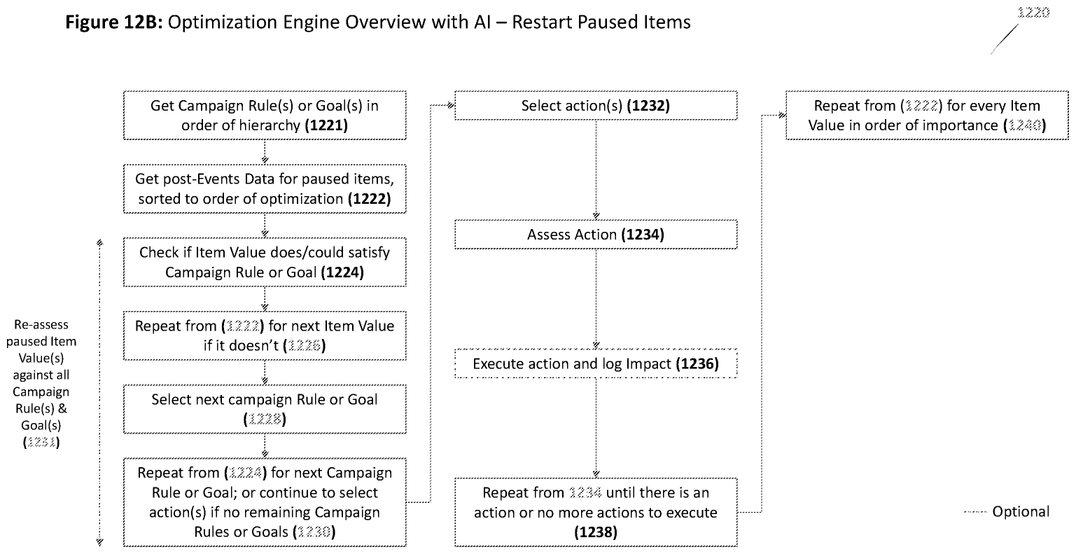

The various types of optimizations that the system does are individually explained in FIGS. 9-12, which includes:
Monitoring the direction of previous optimizations (FIG. 9)
Optimizing items to satisfy Campaign Rule(s) & Goal(s) (FIG. 10)
Optimizing items to maximize Campaign Rule(s) & Goal(s) (FIG. 11)
Re-evaluating previously paused items (FIG. 12)

In a preferred embodiment, using the recalculated metrics that incorporate the impact of events (or remove the impact of other optimizations as when monitoring direction), each item value is tested against the campaign rule or goal [808]. An action is then selected [1300]; which may include doing nothing, pausing an item, resuming an item, or changing the bid to satisfy a campaign rule or goal.

In a preferred embodiment, every action is assessed prior to being executed [1400]. The system checks whether a similar action on the item being optimized had previously failed (been reversed). In so doing, artificial intelligence (“AI”) is created by performing different action(s) if an action being selected has previously failed (wherein the actual “effect” of the optimization did not move the campaign in the direction of a particular rule or goal). The system can test for the impact of an action on other item values, by comparing the estimated impact of the action against the current performance of other item values [1400(1406)]. For example, if the estimated impact of the action is a 10% reduction in ROI, and the sum of item values that currently have a 10% ROI exceed the benefit of the action (such as the sum of items having $100 profit and the item being optimized would have $10 profit)—the action would not be executed, as it would cause profit to drop. Similarly, if unpausing an item would cause active items to pause—but the total profit from those items is lower than the anticipated profit from the currently paused item, then the system would unpause the item (even though it would cause other less important items to be paused in subsequent optimizations). If the action's impact will be positive, it would be executed [814]; otherwise, the next possible actions would be assessed [1400] until there is an action (or not more actions to execute) [816].

In a preferred embodiment, if an action is taken by the system, aside from it being logged in the database 110, its impact is estimated and registered as an “event” as well [814]. The impact calculation depends on the action taken. For example, if an item value is paused, impact may be gauged by comparing the ROI of active item values against the prior ROI of active item values inclusive of the item value that is being paused. Alternatively, if the action is reversing a previous optimization, the “event” created for the previous action would be deleted by the system, and possibly a new event created to reverse that post-event change (which removes the impact of the action being reversed).

As shown, several of the steps are repeated between most optimization methodologies; such as obtaining campaign rules and goals [202], getting and sorting post-events data [210], selecting action(s) in step 810 (described in more detail in [1300]), assessing action(s) [1400], executing actions and logging impacts [814], or assessing other actions until one is executed (or there are no possible actions remaining) [816]. The exception to using post-events data in analysis is when the system is monitoring the direction of previous optimizations. In that case, the raw data must be used after discounting the impact of other optimizations, as the system would need to assess the effectiveness of actions that were taken based on the post-events data itself.

Optimization-specific steps in 806 are those unique to each optimization process, in order to normalize the data for comparisons with campaign rules and goals. For example, when monitoring the direction of previous optimizations, several steps unique to the optimization are performed [927] that remove the impact of other optimizations on data, before the impact of the selected optimization itself can be compared to the campaign rules and goals. When optimizing to maximize campaign rules and goals, the impact of pausing less important item values is estimated and applied to the item being optimized [1128], before it is tested against campaign rules and goals. Similarly, when the optimization is to re-evaluate paused items, each item value is compared to all campaign rules and goals before an action is selected [1231].

Step 810 to select action, when performed, needs to ensure a different action is done rather than repeating a previously failed one [812].

Step 820 is optionally performed. It is optional because for optimization actions where Campaign Rule(s) & Goal(s) are compared to the “Direction of Previous Optimizations” or “Post-Events Data for Paused Item Values”—the comparison with every Campaign Rule & Goal is performed at the optimization-specific step before deciding whether or not to take an action. As such, the first select Campaign Rule or Goal is simply to determine the order of optimizations.

### 1) Optimization: Monitoring Direction of Previous Optimizations

FIG. 9A relates to a non-limiting exemplary method to determine the Direction of Previous Optimizations, in order to ensure that they are satisfying campaign rules and goals. To assess the effect of optimization [904], the system first obtains the raw data before and after the previous optimization event for the impacted items [902]. In a novel approach, the system then removes the impact of other optimizations on the data [904]. This is achieved by:
a. Retrieving the raw data before and “after” the optimization for the impacted item(s);
b. Calculating the “cumulative impact” of all other subsequent optimizations that impacted the selected item(s);
c. Deducting the cumulative impact from the “after” data of the selected item(s); and
d. Comparing the raw data before the optimization to the data above (after removing the impact of other optimizations), to determine whether said optimization is moving in the correct direction)

Other simpler—but less accurate—approaches can also be used to remove the impact of other optimizations. For example, one methodology might be determining a baseline performance change in other items (excluding the one being optimized) that impact the optimized item(s), from the point of optimization until the end of the period being analyzed. Then, said baseline performance change can be deducted from the before/after change of the optimized item(s) to determine the optimization's true impact.

The optimization can impact the item value itself (such as increasing profitability by lowering a bid), or other items (such as pausing an underperforming item value to improve the overall campaign's profitability). While pausing an underperforming ad is detrimental to it, the overall campaign benefits. Whether an optimization is intended to benefit the item value itself can be determined by separately logging the intended impact, or by gauging the items that the optimization impacts. For example, pausing an underperforming placement—“games.com”—would not benefit the particular placement itself, but it would other items (such as profitability of a particular device). The optimization would have an estimated positive impact on other items, but not itself. On the contrary, reducing the bid on a particular placement would increase its profitability (primary objective), but simultaneously also benefit other items. It is thus important to consider the intention of the optimization when monitoring the direction, since gauged in isolation, pausing an item would be contrary to most campaign objectives.

If the optimization event's estimated impact differs from the actual, the system would update the impact multiplier to reflect the true value [906]. The performance prior to the optimization can be compared to the post-optimization (after discounting the estimated impact of other optimizations), to confirm that the data is moving in the correct direction to satisfy all campaign rules and goals [908].

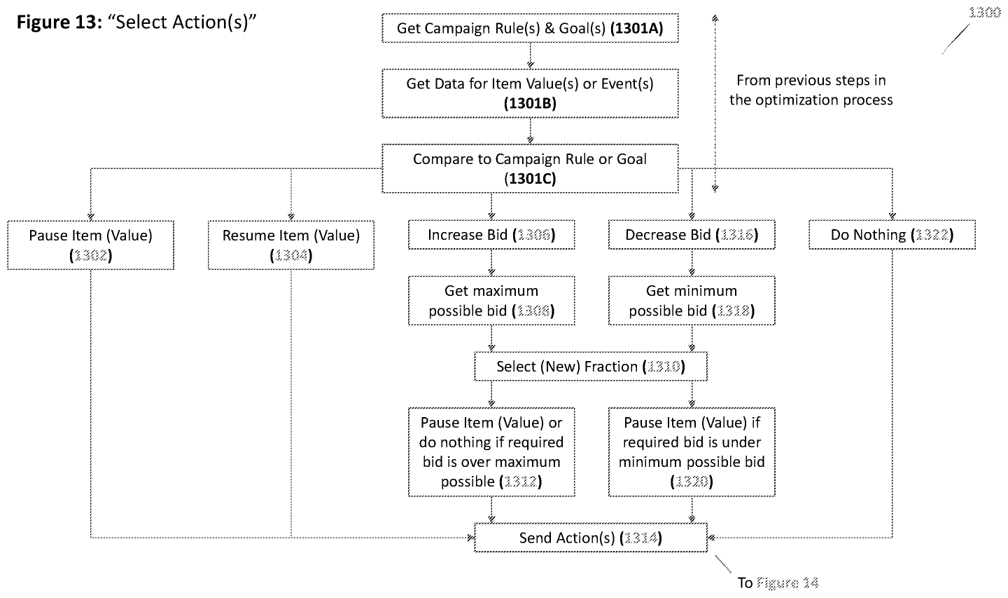

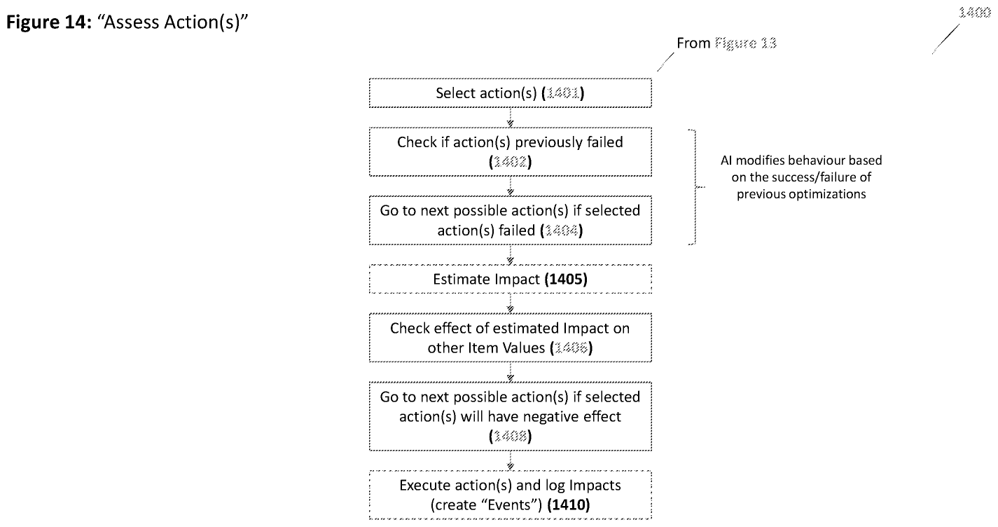

After calculating the new impact multipliers in Step 906, output of the result may be compared to campaign rules and goals as performed with regard to Step 908, taken from Step 802. Actions may be selected in Step 910 as described with regard to FIG. 13. The actions may be assessed in Step 912 as described with regard to FIG. 14. Execution of actions and logging of impacts may be determined with Step 914 as described with regard to FIG. 8.

Whereas FIG. 9A generally shows how each previous optimization event's direction is tested, FIG. 9B describes the overall process for all previous optimizations in greater detail. Campaign rules and goals may be obtained for a Process 920 in Step 921. Next, previous optimization events are obtained to satisfy a particular campaign rule or goal, and sorted to order of optimization in Step 922. Raw data is obtained before and after optimization for the overall campaign or impacted items in Step 923. These may all be performed as previously described.

Next, the impact of other optimizations on data may be removed in Step 924. The change in performance of the campaigns/impacted items before and after optimization is calculated in Step 925. Based on this, the event's impact multiplier is updated with the actual impact in Step 926. Collectively, Steps 923 to 926 help assess the effect of prior optimizations [927].

In Step 928, a check is performed to see if data is moving in the correct direction to satisfy the campaign rules and goals. One or more actions are selected in Step 929, which may include actions to revert the prior optimization. The actions may be selected as described with regard to FIG. 13.

Next, an action is assessed in Step 930, which may be performed as regard to FIG. 14. The action is executed and the impact is logged in Step 931 as described, for example, with regard to FIG. 8. Step 932 repeats the process from 930, of assessing and executing/logging the impact of every action, until an action is taken or there are no further actions left to execute. In Step 933, the entire process repeats for every prior optimization event from 923.

FIG. 9C shows a detailed process for determining optimizations, for example with machine learning or artificial intelligence, in a Process 940. Sets of campaign rules and goals are received in Step 941 which, for example, may be performed according to the information in FIG. 2.

Optionally the machine algorithm is implemented as an AI engine (not shown) which comprises a machine learning algorithm comprising one or more of Naïve Bayesian algorithm, Bagging classifier, SVM (support vector machine) classifier, NC (node classifier), NCS (neural classifier system), SCRLDA (Shrunken Centroid Regularized Linear Discriminate and Analysis), Random Forest. Also optionally, the machine learning algorithm comprises one or more of a CNN (convolutional neural network), RNN (recurrent neural network), DBN (deep belief network), and GAN (generalized adversarial network).

Sets of previous traffic and tracking data are received in 942 which also may be formed with regard to FIG. 2, for example. The artificial intelligence machine learning model is trained on the data and campaign rules and goals in Step 943.

Next, new data under rules/goals is received in 944. A factor to maximize is also received in 946. The optimizations are determined in 948 by the machine learning algorithm. The optimizations executed in 950. After optimizations have been formed, data is received in 952. This can be used to retrain the model on the new data in 954.

### 2) Optimization: Satisfaction of Campaign Rule(s) & Goal(s)

FIG. 10 relates to non-limiting, exemplary methods of optimization to check whether items are satisfying campaign rules and goals. To assess whether the campaign rules and goals are satisfied, the system first uses Retroactive Optimization, for example as described with regard to FIG. 6 to calculate the performance and spend metrics with the impact of“events”.

To recalculate the metrics, the system first identifies all events that apply to the item being optimized. Examples of these events include ones that specifically “impact” the item being optimized, and those that apply to the entire campaign (but were not triggered by the item currently being optimized). In the latter, campaign-level events triggered by the same item being optimized are ignored, since optimizations to a particular type of item would not impact other items of the same type. For example, as they are unrelated, optimizing a specific “placement” (such as “games.com”) would not improve the ROI of other placements. However, optimizing the specific placement would impact the performance of other items (such as the ROI of landing pages running across them) and itself.

Once the event and its impact is logged, the next item value is tested against the campaign rule or goal; or the next campaign rule or goal is tested if all the item values have been tested against the current campaign rule or goal.

FIG. 10A shows an optimization process for each item value. As shown in a Process 1000, campaign rules and goals are obtained in 1002, for example from FIG. 2. Next, post-events matched data is obtained in 1004, as shown in FIG. 2 and explained in FIG. 6. Briefly, “post-Events” means data after application of Events (“Retroactive Optimization”). This is different from data “before and after Event” (which is raw data taken separately before and after an Event to compare).

The campaign rule or goal is compared to the post-events data as performed in Step 1006, for example as described with regard to FIG. 8. One or more actions 1008 are selected, as described, for example with regard to FIG. 13. The actions are assessed in 1010 as described, for example, with regard to FIG. 14. Actions are performed and impacts are optionally logged as described in 1012, which may, for example, be performed as described with regard to FIG. 8.

Next, the process is optionally repeated from Step 1004 for every campaign rule and goal as shown in Step 1014.

Whereas FIG. 10A generally shows how each item value is optimized to satisfy campaign rules and goals, FIG. 10B describes the overall process for all item values in greater detail. As shown in a Process 1020, the process begins by getting the campaign rules or goals in the order of hierarchy, as shown in Step 1022, which may be performed, for example, with regard to FIG. 2. Next the post-events data are sorted according to the order of the item value optimizations, as shown in Step 1024, which may be performed, for example, with regard to FIG. 2. The item value is compared to the campaign rule or goal in Step 1026, as shown with regard to FIG. 8. New actions are selected in Step 1028, as shown with regard to FIG. 13. Actions are assessed in Step 1030, as shown with regard to FIG. 14. Actions are executed and impacts are logged in Step 1032 as described, for example, with regard to FIG. 8.

The process is repeated from Step 1030 until there is an action or no more actions to execute. As shown in Step 1034, which may be performed, for example, with regard to FIG. 8. The process is then repeated from Step 1024 until all active item values are satisfying the campaign rule or goal, as shown in Step 1036. The process may then be repeated from Step 1022 for every campaign rule or goal as shown in Step 1038.

FIG. 10C, FIG. 10D, FIG. 10E, FIG. 10F and FIG. 10G programmatically show the optimization engine. As shown in FIG. 10C, the process 1040 begins with the system selecting the campaign to optimize and then retrieving the campaign rules. For each rule, the system performs calculations using post-event data [Figure 10D] and then optimizes each item value using the post-event data [FIG. 10G]. Once optimization is completed for each item value, the system checks all the item values for the next campaign rule until every campaign rule is tested.

FIG. 10D shows how the post-events data is calculated. The process 1060 first extracts the events applicable to the campaign rule. It then applies the impact multiplier of the events to the data, as per FIG. 10E and FIG. 10F, to calculate the post-events data to be used in optimizations.

After the post-events data is calculated, every item value is optimized based on it in FIG. 10G. This process 1080 determines whether the campaign rule has been satisfied. If the answer is “Yes,” then the system checks the next “Item Value” in FIG. 10C. If the answer is “No,” the system calculates a new bid (or any other action), executes/logs the action, and then estimates/logs the impact. The system continues by checking the next “item value” in FIG. 10C until all item values are satisfying the campaign rules and goals.

### 3) Optimization: Maximization of Campaign Rule(s) & Goal(s)

FIG. 11 shows a non-limiting exemplary system that attempts to maximize the campaign rules and goals (rather than simply satisfying them). As with previous optimization methodologies, the system first sorts all post-event data by importance. It then selects the most important item value, and gauges the impact of pausing/optimizing lesser important ones. Whereas “pausing” an item is self-explanatory, an item in this scenario can be “optimized” where the traffic source permits lowering the bid to below what it is currently set.

While not exhaustive, below are examples of factors that the system would take into consideration when assessing which items to pause/optimize to maximize campaign rules and goals:
Only non-solitary item values would be paused. This is because if the system pauses the only value that exists for an item (such as a campaign where “games.com” is the only placement), the campaign would effectively be paused
Items that would have an impact on traffic volumes would optionally not be paused first, such as placements or devices. Specific ads or landing pages (non-traffic source items) would be paused/optimized first, as these do not exclude entire audience segments that would lower traffic
As explained previously, only “other” items have an impact during optimizations. For example, pausing a placement would not improve the ROI of another placement (since both are independent). To improve the ROI of a certain placement, the system must look at other items to optimize (such as the landing pages)

The system can estimate the impact of pausing/optimizing lesser important item values by comparing the item value's performance against the average of the item. For example, if “games.com” has a ROI of 10%, while all placements have an average ROI of 12%, pausing “games.com” would improve the campaign's ROI. The estimated impact of pausing/optimizing these items is then applied to the more important item value being optimized. Before the selected lesser-important item values are actually paused/optimized, this estimated impact on the important item is used to determine whether the campaign rules and goals would be maximized.

After executing any actions, the system continues repeating the process for the next most important value, thereby optimizing the campaign to maximize the campaign rules and goals (rather than simply satisfying them).

FIG. 11A shows maximizing campaign rules and goals for each item, in a Process 1100. The process begins with Step 1101A where campaign rules and goals are obtained, as shown with regard to FIG. 2, for example.

Next, post-events matched data sorted to the order of optimization is provided with regard to Step 1101B as shown with regard to FIG. 2, for example. The impact of pausing or optimizing less important item values is determined with regard to Step 1102. The estimated impact on the item value being optimized is determined in Step 1104. Next, after applying the estimated impact of pausing lesser important item values from Step 1104, the campaign rule or goal is compared to post-events data in Step 1106 as shown with regard to FIG. 8, for example. Actions are selected in Step 1108 which may, for example, be performed with regard to FIG. 13. The actions are assessed in Step 1110 which may be performed with regard to the description in FIG. 14.

Actions are executed, impacts are optionally logged in Step 1112 as shown with regard to FIG. 8, for example. The process is optionally repeated from Step 1101B for the next most important item value until all active ones are tested, and then from 1101A for every campaign rule and goal as shown with regard to Step 1114, for example.

Whereas FIG. 11A generally shows how each item is optimized to maximize campaign rules and goals, FIG. 11B describes the overall process for all items in greater detail. In a Process 1120, campaign rules or goals are obtained in order of hierarchy in Step 1121, which may be performed, for example, with regard to FIG. 2. Post-events data is obtained and sorted to the order of item value importance in Step 1122, as shown, for example, with regard to FIG. 2. The most important non-optimized item value is selected in Step 1123, or the “next” most important item value on each subsequent repetition for the same campaign rule or goal. The impact of pausing or optimizing lesser important item values is calculated in Step 1124, as described previously. The estimated impact of pausing or optimizing lesser important item values is applied to the one being optimized in Step 1126.

Optionally, between steps 1123-1126, for example at the end of the sequence of steps or as a parallel process, at step 1128, the impact of pausing one or more items, which may be less important item(s), is assessed.

Calculating such an impact may optionally only apply to non-solitary values of an “item”. If the only value that exists for an item is paused, the campaign would effectively be paused. Optionally, a decision could be made to not pause items such as placements or devices, which would have an impact on the traffic volumes. Pausing specific ads or landing pages (non-traffic source items) wouldn't exclude audience segments and lower traffic, and so may be acceptable. Another aspect may include considering “other” items when deciding whether to pause items. For example, pausing a “placement” would not improve the ROI of another “placement” (since both are independent). To improve the ROI of a certain placement, the system preferably considers other items (such as the landing pages) that it can pause. Another aspect of calculating the impact may include calculating estimated impact by comparing item value's performance with the average of the entire item. For example, if the item value's performance falls short of the item's average, pausing it would usually increase the campaign's performance.

Next, the selected item value, preferably including the estimated impact as previously described, is compared to the campaign rule or goal in Step 1130. An action is selected if a more important item value, for example as obtained from step 1123, benefits from optimizations to a lesser important item value, in Step 1132. This may be performed, for example, as described with regard to FIG. 13.

The impact of the actions are then assessed in 1134 as described, for example, with regard to FIG. 14. Actions are executed and impacts are optionally logged in Step 1136 as described, for example, with regard to FIG. 8.

The process, at Step 1138, is preferably repeated from Step 1134 until there is an action or no more actions, for example as described with regard to FIG. 8. This part of the process is best understood with the following explanation and example. Every “action” is assessed. (See FIG. 13 for possible actions, such as “pause item,” “resume item,” “increase item,” “increase bid,” “decrease bid,” etc.). Assume that the first possible action for the system is “decrease bid.” However, when the system assesses the action in Step 1134, as per FIG. 14, the system determines that the above action has previously failed. As a result, the system does not execute the action and log impact in Step 1136. Instead, in Step 1138, it repeats from Step 1134 to assess the next possible action until there are no more actions that the system can execute. In a different scenario, if the system assesses an action that has not previously failed in Step 1134, the system would execute it at Step 1136 and estimate/log its impact. It can then continue to the next step as “there is an action”.

The process is then optionally repeated from Step 1123 for every item value from the most to least important, as shown in Step 1140, for example, as previously described.

Next step, the process is repeated from Step 1121 for every campaign rule and goal, as shown in Step 1142, for example, as previously described.

### 4) Optimization: Restarting of Paused Items (Values)

FIG. 12 shows a non-limiting, exemplary system to restart previously paused items. At some point, the compounded multiplier for an item type may be sufficient to make previously paused item values satisfy the campaign rules and goals. To achieve this, the system may calculate the compounded impact multiplier for the item (going backward from the time that a particular item value was paused), and compare it against the margin when the item value was paused. If the compounded multiplier is in excess of the item value's deficit in satisfying all campaign rules and goals, it can then be restarted.

FIG. 12A shows an overview of re-assessing every paused item value. When determining whether to unpause an item, the system assesses whether an “item value” satisfies all campaign rules and goals before unpausing the item value. As shown in FIG. 12A, the process 1200 begins with obtaining campaign rules and goals in Step 1202. Next, the system obtains post-event matched data in Step 1204. Then, it compares every campaign rule and goal to the post-events data in Step 1206. After the comparison, the system selects action(s) in Step 1208 and assesses the impact of these action(s) in Step 1210. The system subsequently executes the action(s) and optionally logs the impact of the action(s) in Step 1212. The system only selects an action to unpause the item value if it satisfies all of the campaign rules and goals.

Whereas FIG. 12A generally shows each paused item value is re-assessed using post-events data, FIG. 12B describes the overall process for all paused item values in greater detail. In a Process 1220, the process begins in Step 1221, where campaign rules and goals are obtained in order of hierarchy, as described, for example, with regard to FIG. 2.

Next, post-events data for paused items are obtained in Step 1222, sorted to the order of optimization, as described, for example, with regard to FIG. 2. The interval of the post-events data would optionally be based on the campaign rule or goal. For example, if the campaign rule is optimizing to the “last 7 days”, the post-events data would be for the 7 days preceding when the item value was paused. Next, it is checked whether the item value could satisfy the campaign rule or goal in Step 1224, which may be performed, for example, as described with regard to FIG. 8.

The process is repeated from Step 1222 for the next item value, if in fact this item value does not satisfy the campaign rule or goal, as shown in Step 1226. If the item value does satisfy the campaign rule or goal, the next one in the hierarchy is selected in Step 1228 to test. The process is repeated from 1224 for the next campaign rule or goal, to ensure that each one is satisfied after applying the impact of events to the item value. Alternatively, the process continues to select action(s) if no remaining campaign rules or goals are present in Step 1230.

Optionally, it is possible to reassess the paused item values against all campaign rules and goals as shown with regard to Step 1231, such that Steps 1224 to 1230 may optionally be repeated at least once.

In Step 1232, one or more actions are selected, for example, with regard to FIG. 13. In Step 1234 the action is assessed as described, for example, with regard to FIG. 14. The action is executed and the impact is logged in Step 1236 as described, for example, with regard to FIG. 8. The process is optionally repeated from Step 1234 until there is an action, or no more actions are provided to execute, as shown in Step 1238 as described, for example, with regard to FIG. 8.

The process is then optionally repeated from Step 1222 for every item value in order of importance in Step 1240.

### Select Action(s)

FIG. 13 shows a non-limiting exemplary process for selecting actions and lists the possible actions that the optimization engine can take (e.g., “pause item,” “resume item,” “increase bid,” decrease bid,” or “do nothing”). As shown in the Process 1300, campaign rules and goals are obtained in Step 1301A as described, for example, with regard to FIG. 2. Next, data for item values or events is obtained in 1301B as described, for example, with regard to FIG. 2. This information is then compared to a campaign rule or goal as shown in 1301C, as described, for example, with regard to FIG. 8. The previous steps are from the prior optimization processes, on the basis of which action(s) are selected.

Based on the comparison to the campaign rule or goal, multiple actions are possible. In 1302, the pausing of an item value is considered. For example, this may be necessary when an item value is not satisfying a minimum profit rule, despite it being impossible to reduce the bid further based on a floor set by the traffic source. Resuming item values is considered in 1304, particularly when reverting a previously failed action or re-assessing paused items. Increasing the bid is considered in 1306. Decreasing the bid is considered in 1316. The system may also take no action in 1322, such as when the campaign rule or goal is already being satisfied.

Some actions may necessitate additional steps. As an example, if the bid is to be increased in 1306, the maximum possible bid is obtained in 1308, a new fraction is selected in 1310. Optionally, the item value may be paused if the required bid to satisfy the campaign rule or goal is over the maximum possible bid in 1312. Alternatively, in 1312, the system may do nothing if the selected fraction is over the maximum possible, and the item value is satisfying the campaign rule or goal already. Thereafter, the selected action(s) are forwarded to be assessed in 1314, as explained further in FIG. 14.

If the bid is to be decreased, then from 1316, the minimum possible bid is obtained in 1318. A new fraction is selected in 1310. The item value is paused if the required bid is under the minimum possible bid in 1320. Thereafter, the selected action(s) are forwarded to be assessed in 1314, as explained further in FIG. 14.

### Assess Action(s)

FIG. 14 shows a non-limiting exemplary method for assessing actions, as shown in a Process 1400. An action is selected in 1401, for example, from the results of FIG. 13.

In 1402, it is checked whether the action(s) have previously failed. Then, in 1404, the next possible action is selected if the action has failed. Impact is assessed in 1405 as described, for example, with regard to FIG. 2.

The effect of the estimated impact on other item values is assessed in Step 1406. The system can do this by comparing the estimated impact against the current performance of other item values in the fetched post-events data. For example, if the estimated impact is −10% ROI (to increase the bid for more dollar profits), and the sum of item values that currently have a 10% ROI exceed the benefit of the action (such as if the sum of items currently have $100 profit and the item value being optimized has $10 profit), the action would cause the profit to drop and would not be executed. If the selected action will have a negative impact, the next possible action is selected to be assessed instead in Step 1408. If the action will have a positive estimated impact, it is executed and the impacts are logged in Step 1410 as described, for example, with regard to FIG. 8.

### Optimization: Other Methodologies

Other novel optimization methodologies are also permissible by the system. For example, the novel method of storing data also permits imitation of second-price auctions for platforms that do not support it, by obtaining bids at the lowest cost possible. This is possible by logging the ad position for each item value at defined intervals, lowering the bid until the ad position drops, and then reverting the bid to the last value in the logs before the ad position dropped.

### Server Overview:

At specific intervals or at the time of optimization, data [200(110)] is obtained/stored from APIs [200(112)] and matched [204]. “Events” can be manually specified by the user [206], and also detected from changes in the data (for example, if the status of an item changed to “paused” in the tracking platform) [208].

When optimizing [200(800)], the system obtains the campaign rules and goals [202]. It then fetches the post-events data [210] based on campaign rules and goals to perform optimizations. The optimization step continuously receives estimated impact of various actions prior to deciding whether to execute them [208]. This relationship between the optimization step and estimating impacts is two-way, as once the optimization engine has decided to execute an action, the estimated impact is also sent back to be stored in the database as an event [110]. Similarly, the actions selected by the optimization engine are relayed to the tracking and/or traffic APIs for the actual execution [112].

While examples are provided, it must be emphasized that the scope of the present invention extends beyond these. For example, the present invention would extend to a tracking platform attempting to incorporate the above methods; including the methodology to associate dissimilarly named items with the traffic source, or the incorporation of events. Further, the system could be extended in the future to incorporate the functionality of a tracking platform as well. Similarly, changing a feature—such as querying the APIs directly rather than fetching/logging reports at certain intervals, or storing data to a database—would still not void the underlying principles behind the Retroactive Optimization methodology.

1-46. (canceled)

47. A system for optimizing and managing advertising campaigns according to hierarchical relationships between items to be optimized, the items being received from a traffic source, the system comprising
a. a computer network;
b. a user computational device;
c. a server in communication with said user computational device through said computer network, where said server comprising an application programming interface (API) module and an optimization engine, wherein the items are received from the traffic source through said API module; and
wherein said optimization engine receives information regarding performance of an advertising campaign as items from said traffic source, and determines a plurality of potential optimizations, wherein said optimization engine models an effect of differentially applying said plurality of potential optimizations on said advertising campaign and determines an appropriate change to one or more parameters of said advertising campaign according to said modeled effect, wherein said optimization engine models an estimated impact of potentially thousands of optimizations and applies immediately the estimated impact in subsequent calculations before actual information even reflects an optimization's change to improve campaign efficiency.

48. The system of claim 47, wherein the computer network is the internet, wherein said user computational device comprises a user input device, a user interface, a processor, a memory, and a user display device; and wherein said server comprises a processor, a server interface, and a database.

49. The system of claim 48, further comprising a traffic source server in communication with said API module of said server for providing the items for optimization as traffic source data, wherein traffic source server comprises a tracking source API for communicating traffic source data; and further comprising a tracking platform server in communication with said API module of said server, wherein tracking platform server comprises a tracking platform API for communicating tracking platform data, wherein said tracking platform data and said traffic source data are provided with sufficient granularity to correspond with a granularity of the modeled optimizations.

50. The system of claim 49, wherein said granularity of said modeled optimizations comprises separate tracking platform data and separate traffic source data for each parameter of said advertising campaign, data in a time period corresponding to a time period analyzed by said optimization engine, and data of a periodic frequency corresponding to the periodic frequency analyzed by said optimization engine.

51. The system of claim 50, wherein said optimization engine uses multiple optimization methodologies to optimize items according to hierarchical relationships.

52. The system of claim 51, wherein said optimization engine monitors the direction of previous optimizations, receives information about an effect of each of a plurality of previous optimizations, and determines a direction of each previous optimization according to an effect on said advertising campaign, wherein said direction is selected from the group consisting of positive, negative or neutral.

53. The system of claim 52, wherein said optimization engine optimizes items to satisfy and to maximize advertising campaign rules and goals.

54. The system of claim 53, wherein said optimization engine determines an optimization comprising pausing an item, evaluates a previously paused item, and restarts a paused item according to said evaluation.

55. The system of claim 54, wherein said optimization engine applies a retroactive optimization for modeling according to an impact of each optimization as an event, wherein said retroactive optimization is calculated according to: f(c)=ρ[sum(n)×multipliers(n)]|n=0 to ‘c’, wherein: ‘n’ is the event number in the $events array (starting from 0), ‘c’ is the number of total events: count($events-1), sum(n) is the raw performance/spend metric total (for every item value) between $events[n-1][‘timestamp’] and $events[n][‘timestamp’] and multipliers(n) is the compounded impact of all events that apply between $events[n-1][[‘timestamp’] and $events[n][‘timestamp’],

56. The system of claim 55, wherein said sum is calculated according to a predetermined time period and wherein said sum is optionally calculated upon detection of input of a marker event with a timestamp that correlates with the end of the period being analyzed to said optimization engine.

57. The system of claim 56, wherein said optimization engine models said optimization before optimizing said advertising campaign based on input user-defined rules and goals, wherein said optimization engine receives said traffic source and tracking platform data more than once, wherein at least one change occurs between receipts of said data, and wherein said optimization engine performs said modeling according to said change in data, and where said API module provides support for enabling modules on said server to operate in an API agnostic manner and said API module transmits communication abstraction for said tracking platform API and for said traffic source API.

58. The system of claim 57, wherein said optimization engine further comprises an artificial intelligence (AI) engine for determining said model of said optimization according to a plurality of previous effects of optimizations on the advertising campaign, and according to currently received traffic source data and tracking platform data; wherein said AI engine comprises a machine learning algorithm comprising one or more of Naïve Bayesian algorithm, Bagging classifier, SVM (support vector machine) classifier, NC (node classifier), NCS (neural classifier system), SCRLDA (Shrunken Centroid Regularized Linear Discriminate and Analysis), Random Forest, CNN (convolutional neural network), RNN (recurrent neural network), DBN (deep belief network), and GAN (generalized adversarial network).

59. The system of claim 58, wherein each of said user computational device and each server comprises a processor and a memory, wherein said processor of each computational device comprises a hardware processor configured to perform a predefined set of basic operations in response to receiving a corresponding basic instruction selected from a predefined native instruction set of codes, and wherein said server comprises a first set of machine codes selected from the native instruction set for receiving said traffic source data and said tracking platform data, a second set of machine codes selected from the native instruction set for operating said optimization engine to determine a model of optimizations, and a third set of machine codes selected from the native instruction set for selecting a plurality of optimizations for changing said one or more parameters of said advertising campaign.

60. The system of claim 59, wherein the traffic source is selected from the group consisting of: a website that sells ads, including but not limited to content websites, e-commerce websites, classified ad websites, social websites, crowdfunding websites, interactive/gaming websites, media websites, business or personal (blog) websites, search engines, web portals/content aggregators, application websites or apps (such as webmail), wiki websites, websites that are specifically designed to serve ads (such as parking pages or interstitial ads); browser extensions that can show ads via pop-ups, ad injections, default search engine overrides, and/or push notifications; applications such as executable programs or mobile/tablet/wearable/Internet of Things (“IoT”) device apps that shows or triggers ads; in-media ads such as those inside games or videos; as well as ad exchanges or intermediaries that facilitate the purchasing of ads across one or more publishers and ad formats.

61. The system of any of 60, wherein the tracking platform comprises a software, platform, server, service or collection of servers or services that provides tracking of items for one or more traffic sources and wherein items from a traffic source that are tracked by the tracking platform include one or more of performance (via metrics such spend, revenue, clicks, impressions and conversions) of specific ads, ad types, placements, referrers, landing pages, Internet Service Providers (ISPs) or mobile carriers, demographics, geographic locations, devices, device types, browsers, operating systems, times/dates/days, languages, connection types, offers, in-page metrics (such as time spent on websites), marketing funnels/flows, email open/bounce rates, click-through rates, and conversion rates.

62. A method of optimizing an advertising campaign, the steps of the method being performed by a computational device, the method comprising:
a. receiving timestamps of every event;
b. retrieving the actual raw data from the start (or previous optimization event if repeating) until the next event timestamp (or end of period being assessed if there are no more events);
c. multiplying the actual raw data with the compounded (estimated) impact of subsequent events/optimizations;
d. adding the post-Events sum to a running total;
e. repeating steps from step ‘b’ from the previous event until the next one (or end of period being assessed if there are no more events).

63. A method for optimizing advertising campaigns according to hierarchical relationships between items to be optimized, the method comprises
a. receiving client inputs from a user computational device;
b. receiving campaign rules and goals for client inputs;
c. receiving manual events from client inputs and transmitting manual events to a database;
d. retrieving data using an application programming (API) module of a server that enables communication with external tracking platforms and traffic sources;
e. storing matched data in database, where matched data may be used for applying events;
f. optimizing item values based on campaign rules and goals, said post-events data, and estimated impact;
g. estimating impact of selected optimizations, which are stored in a database;
h. transmitting optimized item values to an application programming (API) module of a server; and
i. executing, by API module, the selected actions on the tracking platforms and traffic sources;
j. wherein said retrieving data using said API further comprises matching tracking and traffic data with client inputs and optimized item values from said API module;
k. wherein the matching tracking and traffic data comprises
i. getting advertisement URL from traffic source campaign, detecting traffic source dynamic tokens in advertisement URL, detecting URL parameter of tracking link for dynamic token, and storing item relationship;
ii. getting traffic source and tracking platform items, getting item values, checking for common item values between items; matching and confirming items, and storing item relationships; and
iii. defaulting to tracking platform and traffic source items that are manually specified;
l. wherein said storing data process comprises
i. determining report intervals,
ii. determining a report for every item, wherein data is obtained from the tracking platform and from said traffic source, and stored into a database;
iii. repeating step ‘ii’ for every interval;
iv. getting item relationships;
v. matching and storing tracking platform and traffic source data for every item value; and
vi. estimating and logging impact of detected changes.

64. The method of claim 63 implemented according to a system comprising
a. a computer network;
b. a user computational device;
c. a server in communication with said user computational device through said computer network, where said server comprising an application programming interface (API) module and an optimization engine, wherein the items are received from the traffic source through said API module; and
wherein said optimization engine receives information regarding performance of an advertising campaign as items from. said traffic source, and determines a plurality of potential optimizations, wherein said optimization engine models an effect of differentially applying said plurality of potential optimizations on said advertising campaign and determines an appropriate change to one or more parameters of said advertising campaign according to said modeled effect.

65. A method of optimizing advertising campaigns according to hierarchical relationships between items to be optimized, the optimization method comprises
a. getting campaign rules and goals;
b. getting data from item values and events, where are sorted to order of optimization;
c. preforming steps specific to the optimization type;
d. comparing to campaign rules and goals;
e. selecting actions;
f. assessing action;
g. executing action and logging impact;
h. repeating steps from ‘f’ until there is an action or no more action to execute;
i. repeating steps from step ‘b’ for next item value, or next “Optimization” event if Monitoring Direction; and
j. repeating steps from step ‘a’ for every campaign rule and goal.

66. The method of claim 65, where the optimization method performs one or more of monitoring direction of previous optimizations, optimizing to campaign rules and goals, maximizing campaign rules and goals, or restarting paused items
a. where said monitoring direction of previous optimizations further comprises
i. receiving data from database of before and after a previous optimization;
ii. assessing effect of said previous optimization;
iii. calculating new impact multipliers;
iv. comparing to campaign rules and goals;
v. selecting actions;
vi. assessing actions; and
vii. executing actions;
b. wherein said assessing effect of previous optimization entails
i. obtaining raw data before and after a plurality of previous
ii. optimizations to satisfy a campaign rule or goal;
iii. removing impact of other optimizations on data;
iv. comparing change in campaign or impacted items' performance before and after selected optimization;
v. updating an impact multiplier for each previous optimization with actual impact; and
vi. checking if data is moving in correct direction to satisfy campaign rules and goals;
c. where optimizing campaign rules and goals comprises
i. getting campaign rules and goals in order of hierarchy;
ii. getting post-Events data, which is sorted to order of item value optimizations;
iii. comparing item value to campaign rules and goals;
iv. selecting new actions;
v. assessing action;
vi. executing action and logging impact;
vii. repeating steps from step ‘v’ until there is an action or no more actions to execute;
viii. repeating steps from step ‘ii’ until all active item values are satisfying campaign rule or goal;
d. where maximizing campaign rules and goals comprises
i. getting campaign rules and goals in order of hierarchy;
ii. getting post-Events Data, which is sorted to order of item value optimizations;
iii. selecting (next) most important non-optimized item value;
iv. calculating impact of pausing or optimizing lesser important item values;
v. applying estimated impact of pausing or optimizing to selected item value;
vi. comparing selected item value (including the estimated impact from last step) to campaign rule and goal;
vii. selecting actions if more important item value benefits from optimizations to lesser important item values;
viii. assessing action;
ix. executing action and logging impact;
x. repeating steps from assessing action until there is an action or no more action execute;
xi. repeating steps from step ‘iii’ for every item value, from most to least important; and
xii. repeating steps from step ‘i’ for every campaign rule and goal;
e. where restarting paused items comprises
i. getting campaign rules and goals in order of hierarchy;
ii. getting post-Events Data for paused items, which are sorted to order of optimization;
iii. checking if item value does or could satisfy a campaign rule or goal;
iv. repeating steps from step for next item value if checked item value cannot satisfy a campaign rule or goal;
v. selecting the next campaign or goal;
vi. repeating steps from step ‘iii’ for all remaining campaign rules and goals; or continuing to select actions if no remaining campaign rules or goals;
vii. selecting actions;
viii. assessing action;
ix. executing action and logging impact;
x. repeating steps from step ‘viii’ until there is an action or no more action to execute; and
xi. repeating steps from step ‘ii’ for every item value in order of importance;
f. where selecting actions comprises
i. getting campaign rules and goals;
ii. getting data for item values or events;
iii. comparing campaign rule or goal to the data to determine whether to pause item (value), resume item (value), increase bid, decrease bid, or do nothing;
iv. sending action or actions, if either pause item (value), resume (value), or do nothing is selected;
v. increasing bid if increase bid is selected, getting maximum possible bid, selecting new fraction, pausing item (value) or do nothing if required bid is over maximum possible, and sending action or actions;
vi. decreasing bid if decrease bid is selected, getting minimum possible bid, selecting new fraction, pausing item (value) if required bid is under minimum possible bid, and sending action or actions;
vii. selecting action or actions;
viii. checking if actions or actions previously failed;
ix. going to next possible action if selected action has failed;
x. estimating impact if action has not failed;
xi. checking effect of estimated impact on other item values;
xii. going to next possible action if selected action will have a negative effect; and
xiii. executing action or actions and logging impact.

67. The method of claim 65, where the optimization method uses an optimization engine comprises an artificial intelligence (AI), where the AI process comprises
a. receiving sets of campaign rules and goals;
b. receiving sets of previous traffic and tracking data;
c. training AI model on data and campaign rules and goals;
d. receiving new data and rules and goals;
e. receiving factor to maximize;
f. determining optimization;
g. executing optimization;
h. receiving data after optimization; and
i. retraining AI model on new data.
